(19) United States
(12) Patent Application Publication
(10) Pub. No.: US 2023/0089061 A1
(43) Pub. Date: Mar. 23, 2023

(54) SPACE RECOGNITION SYSTEM, SPACE RECOGNITION METHOD, INFORMATION TERMINAL, AND SERVER APPARATUS

(71) Applicant: Maxell, Ltd., Kyoto (JP)

(72) Inventors: Yasunobu HASHIMOTO, Kyoto (JP); Naohisa TAKAMIZAWA, Kyoto (JP); Hitoshi AKIYAMA, Kyoto (JP)

(73) Assignee: Maxell, Ltd., Kyoto (JP)

(21) Appl. No.: 17/797,445

(22) PCT Filed: Feb. 5, 2020
(86) PCT No.: PCT/JP2020/004388

§ 371 Date: Aug. 4, 2022

(51) Int. Cl. G06T 7/73; G06V 20/20

(52) U.S. Cl. CPC G06T 7/74; G06V 20/20; G06T 2207/30204

(57) ABSTRACT

A technique and the like in which an information terminal can measure space to create and register space data and the information terminal can acquire and use the space data is provided. A space recognition system comprising an information terminal including a function of measuring a space and a function of displaying a virtual image on a display surface and having a terminal coordinate system, and an information processing apparatus which performs processing based on a common coordinate system; the information terminal measures a relationship relating to a position and an orientation between the terminal coordinate system and the common coordinate system, and the information terminal matches the terminal coordinate system and the common coordinate system based on data representing the measured relationship, and the information terminal and the information processing apparatus share a space recognition.

### TECHNICAL FIELD

The present invention relates to a system and the like for an information terminal to recognize a space.

### BACKGROUND ART

An information terminal such as a head mounted display (HMD) or a smartphone has a function of displaying an image (sometimes referred to as a virtual image or the like) corresponding to a virtual reality (VR), an augmented reality (AR), or the like on a display surface. For example, the HMD worn by the user displays an AR image at a position corresponding to an actual object such as a wall or a desk in a space such as a room.

As prior art examples relating to the above technology, JP-A-2014-514653 (Patent Document 1) is cited. Patent Document 1 describes a technique in which, in a plurality of terminals, the same object in the real space, for example, a desk surface, is recognized as an anchor surface based on camera capture, and a virtual object is displayed on the anchor surface from each terminal, thereby displaying the virtual object at almost the same position.

### RELATED ART DOCUMENT

### Patent Document

[Patent Document 1] Japanese Patent Application Laid-Open Publication No. 2014-514653

### SUMMARY OF THE INVENTION

### Problems to be Solved by the Invention

The information terminal preferably grasps the position, orientation, shape, and the like of an actual object such as a wall, a desk, and the like in a space with as high accuracy as possible in order to be able to display a virtual image suitably in a function such as an AR. The information terminal has a function to detect and measure the space around its own device using cameras and sensors for its grasp. For example, the HMD can detect the reflection point when the light emitted from the sensor of its own device comes back to hit the surrounding object as a feature point, it is possible to obtain a plurality of feature points of the surrounding as point group data. The HMD can configure space data representing the shape or the like of the space (in other words, data for the information terminal to recognize the space) by using such point group data.

However, in the case where the information terminal of the user performs the measurement on a large space or a large number of spaces in the real world, there are problems with respect to efficiency, convenience of the user, workload, and the like. For example, when one user performs an operation of measuring a space in a building with an information terminal, it may take a long time and a large load.

Further, when an information terminal of a certain user measures and grasps a space of a room or the like once and uses the space for AR image display or the like and then reuses the space after that, the efficiency or the like is not good if the space must be measured again.

It is an object of the present invention to provide a technique in which an information terminal can measure space to create and register space data, and an information terminal can acquire and use the space data, and a technique in which the space data and the corresponding space recognition can be shared among a plurality of information terminals of a plurality of users.

### Means for Solving the Problems

A typical embodiment among the present invention has the configuration shown below. The space recognition system of one embodiment includes an information terminal including a terminal coordinate system and having a function of measuring a space and a function of displaying a virtual image on a display surface, and an information processing apparatus performing processing based on a common coordinate system, wherein the information terminal measures a relationship between the terminal coordinate system and the common coordinate system with respect to a position and an orientation, matches the terminal coordinate system and the common coordinate system based on data representing the measured relationship, and the information terminal and the information processing apparatus share recognition of the space.

### Effects of the Invention

According to a representative embodiment of the present invention, the information terminal can measure space to create and register space data, the information terminal can acquire and use the space data, and the space data and the corresponding space recognition can be shared among a plurality of information terminals of a plurality of users.

### BRIEF DESCRIPTION OF THE DRAWINGS

FIG. 1 is a diagram showing a configuration of a space recognition system according to a first embodiment of the present invention;

FIG. 2 is a diagram showing a configuration of a space recognition method of the first embodiment of the present invention.

FIG. 3 is a diagram showing a configuration example of a space according to the first embodiment.

FIG. 4 is a diagram showing an example of sharing measurement of the space in the first embodiment.

FIG. 5 is a diagram showing an example of use of the space in the first embodiment.

FIG. 6 is a diagram showing an example of an external configuration of an HMD which is an information terminal in the first embodiment;

FIG. 7 is a diagram showing a functional block configuration example of the HMD being an information terminal according to the first embodiment.

FIG. 8 is an explanatory view of a coordinate system pairing in the first embodiment

FIG. 9 is an explanatory view of a position transmission or the like in the first embodiment.

FIG. 10 is a diagram showing a processing flow between the information terminal in the first embodiment.

FIG. 11 is a diagram showing a display example by the information terminal in the first embodiment.

FIG. 12A to FIG. 12B are explanatory views of a rotation or the like of the coordinate system in the first embodiment.

FIG. 13 is an explanatory view of a coordinate system pairing or the like according to a second modification of the first embodiment.

FIG. 14 is an explanatory view of a conversion parameter according to the second modification of the first embodiment.

FIG. 15 is an explanatory view of a coordinate system pairing or the like according to a third modification of the first embodiment.

FIG. 16 is a diagram showing a configuration of a space recognition system according to a second embodiment of the present invention;

FIG. 17 is an explanatory view of a coordinate system pairing in the second embodiment.

FIG. 18 is an explanatory view of a fourth modification of the second embodiment.

FIG. 19 is a diagram showing a configuration of a space recognition system of the third embodiment of the present invention.

FIG. 20A to FIG. 20D are diagrams showing a configuration example of a mark in the third embodiment.

FIG. 21 is a diagram showing a processing flow of the information terminal and the server in the third embodiment.

FIG. 22 is an explanatory view of a fifth modification of the third embodiment.

FIG. 23 is a diagram showing a processing flow according to a sixth modification of the third embodiment.

FIG. 24A to FIG. 24B are explanatory views according to the sixth modification of the third embodiment.

FIG. 25 is a diagram showing a first display example by the information terminal in the space recognition system of the fourth embodiment of the present invention.

FIG. 26 is a diagram showing an example of sharing of space in the fourth embodiment.

FIG. 27 is a diagram showing a second display example by the information terminal in the fourth embodiment.

FIG. 28 is a diagram showing a third display example by the information terminal in the fourth embodiment.

FIG. 29 is a diagram showing a fourth display example by the information terminal in the fourth embodiment.

FIG. 30 is a diagram showing a fifth display example by the information terminal in the fourth embodiment.

FIG. 31 is a diagram showing a basic configuration of the present invention.

### DETAILED DESCRIPTION OF PREFERRED EMBODIMENTS

Hereinafter, embodiments of the present invention will be described in detail with reference to the drawings. In all the drawings, the same parts are denoted by the same reference numerals in principle, and a repetitive description thereof is omitted.

### First Embodiment

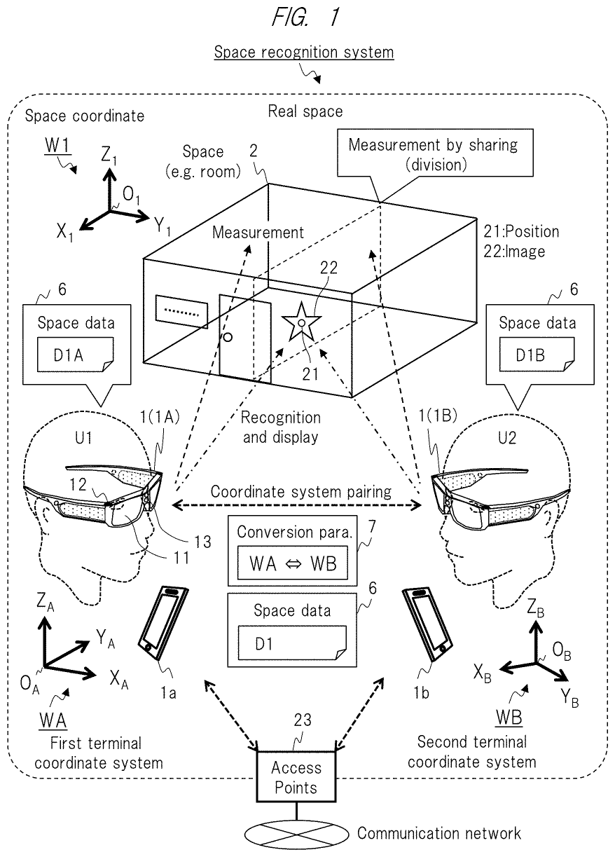

A space recognition system and a method of the first embodiment of the present invention will be described with reference to FIGS. 1 to 12 and the like. Hereinafter, an information terminal device may be referred to as a terminal.

Conventionally, regarding a terminal such as an HMD, a concept of measuring a space to be used by a plurality of terminals of a plurality of users in a spatially or temporally divided manner, creating and registering space data, and a suitable technique therefor have not been sufficiently examined. The space recognition system and method of the first embodiment provides a suitable technique such as measurement of space by such sharing, creation of space data, sharing and reuse of space data, and a series of procedures therefor. The systems and methods efficiently, e.g., quickly, realize measurement of space, creation of space data, sharing and reuse of the space data, and the like.

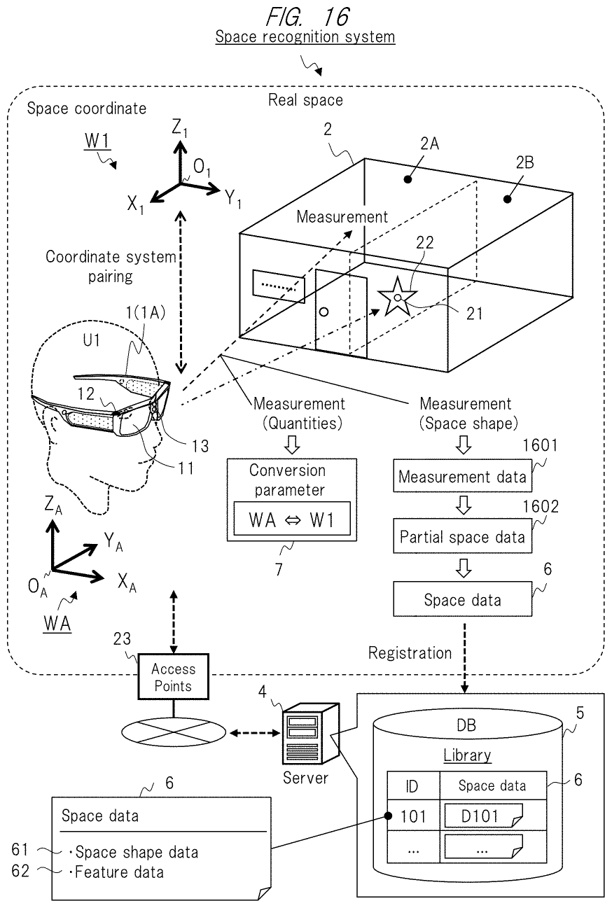

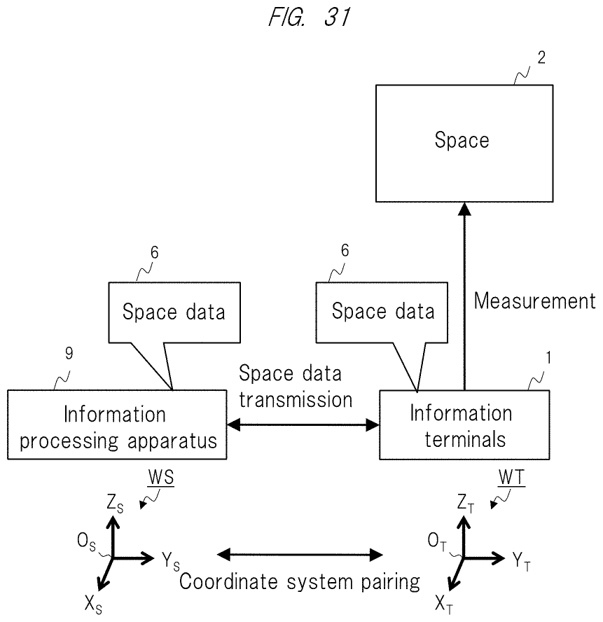

First, the basic configuration of the present invention is shown in FIG. 31. The basic configuration of the present invention comprises an information terminal 1 including a terminal coordinate system WT, and having a function of measuring a space 2 and a function of displaying a virtual image on a display surface, and an information processing apparatus 9 for processing space data 6 described by a common coordinate system WS. The information processing apparatus 9 is an information terminal different from the information terminal 1, or a server 4 to be described later, such as in FIG. 16. The information terminal 1 measures the positional and orientation relationship between the terminal coordinate system WT and the common coordinate system WS, and matches the terminal coordinate system WT and the common coordinate system WS based on data representing the measured relationship. This is called coordinate system pairing, which will be described later. By this coordinate system pairing, the information terminal 1 and the information processing apparatus 9 share space recognition.

The sharing of the space data 6 is performed through the description of the space data 6 by the common coordinate system WS. For example, the information terminal 1 measures the space 2 to acquire the space data 6, and acquires the space data 6 described based on the common coordinate system WS from the information processing apparatus 9. The information terminal 1 converts the space data 6 acquired from the information processing apparatus 9 to the terminal coordinate system WT of its own device, and uses the space data 6 on integrating with the space data 6 measured by its own device. Alternatively, the information terminal 1 converts the space data 6 measured by its own device into a description by the common coordinate system WS, and provides it to the information processing apparatus 9. The information processing apparatus 9 collectively processes and uses the provided space data 6 and the held space data 6.

The space recognition system of the first embodiment shown in FIG. 1 and the like measures the space 2 by the sharing of the plurality of terminals 1 of the plurality of users and creates the space data 6 based on the measurement data. To clarify the surface direction of the object, the shielding relationship between the objects, the space data 6 may include the position of the terminal 1 at the time of measurement (measurement start point). Between a plurality of terminals 1 of a plurality of users, the space data 6 can be provided to each other, shared and used, and the recognition of the position, orientation, and the like in the same space 2 can be shared. This makes it easy to display the same virtual image 22 at a desired same position 21 in the space 2 when using, for example, an AR function between a plurality of terminals 1, so that work, communication, and the like can be suitably realized. According to this system, it is possible to realize more efficient work than the case where the work such as measurement is performed by the terminal of one user. In the first embodiment, the terminal 1 holds the space data 6. The information processing apparatus 9 in FIG. 31 is the terminal 1 in FIG. 1, and the common coordinate system WS is the terminal coordinate system WT of either one of the terminals 1 used as a reference for description when the space data 6 is exchanged between the plurality of terminals 1.

The space recognition system and method according to the first embodiment have a mechanism such as adaptation between coordinate systems related to measurement and recognition of the space 2 in the above sharing. In general, a coordinate system of a space (sometimes referred to as a “space coordinate system”) and a coordinate system of each terminal (sometimes referred to as a “terminal coordinate system”) are basically different coordinate systems, and at least initially do not coincide with each other. Therefore, in the embodiment, at the time of the above sharing, the operation of correlating and matching the terminal coordinate systems of the terminals 1 with each other is performed as “coordinate system pairing”. By this operation, the conversion parameters 7 for coordinate system conversion are set in the terminal 1. In a state in which the coordinate system pairing is established, the positions, orientations, and the like can be mutually converted between the coordinate systems by the conversion parameters 7. As a result, it is possible to share the recognition of the position and the like of the same space 2 between the terminals 1 that perform sharing. Each terminal 1 creates partial space data 6 described in each terminal coordinate system by measurement in sharing. The plurality of partial space data described in each terminal coordinate system can be configured as the space data 6 described in a certain unified terminal coordinate system in units of the space 2 by conversion and integration using the conversion parameters 7.

### [Space Recognition System]

FIG. 1 shows a configuration of a space recognition system according to the first embodiment. In this example, a case will be described in which the space 2 to be used by the terminal 1 is set as one room in the building, and the HMD is particularly used as the terminal 1. The space recognition system according to the first embodiment includes a plurality of terminals 1, for example, a first terminal 1A and a second terminal 1B, which are carried or worn by a plurality of users, for example, a user U1, U2, and a space 2 to be measured or used by each terminal 1. Each terminal 1 creates and holds the space data 6 and the conversion parameter 7. The terminal 1 may be a device such as a smartphone la or 1b or a tablet terminal. Each terminal 1 is connected to a communication network including the Internet, a mobile network, or the like through an access point 23 of a wireless LAN, and can communicate with an external device via a communication network.

The space 2 is an arbitrary space managed by identification or division, and is, for example, one room in a building. In this example, the space 2 of the room is an object of creating the space data 6 by sharing, and is an object of recognition sharing by a plurality of terminals 1.

The plurality of terminals 1 includes, for example, a first terminal 1A (=first HMD) of the first user U1 and a second terminal 1B (=second HMD) of the second user U2. The HMD which is a terminal 1 includes in the housing, a transmissive display surface 11, a camera 12, and a ranging sensor 13 or the like, and has a function of displaying a virtual image of AR on the display surface 11. Similarly, the smartphones 1a and 1b include a display surface such as a touch panel, a camera, a ranging sensor, and the like, and have a function of displaying a virtual image of AR on the display surface. When a smart phone or the like is used as the terminal 1, a function or the like substantially similar to that of the HMD can be realized. For example, the user sees a virtual image such as an AR displayed on a display surface of a smartphone held in his or her hand.

Each terminal 1 has a function of performing coordinate system pairing between the own device and the other terminal 1. Each terminal 1 measures the relationship between the terminal coordinate system of the own device (e.g., the first terminal coordinate system WA) and the terminal coordinate system of the counterpart (e.g., the second terminal coordinate system WB), generates a conversion parameter 7 based on the relationship, and sets the relationship to at least one of the own device or the counterpart. The plurality of terminals 1 (1A, 1B) measure the object space 2 in a shared manner, and create respective partial space data 6 (sometimes referred to as “partial space data”). For example, the first terminal 1A creates space data D1A, and the second terminal 1B creates space data D1B. The plurality of terminals 1 can generate space data 6 (e.g., space data D1) in units of the space 2 from the partial space data 6, and can share the recognition of the space 2 using the space data 6. Terminal 1 has a function of measuring the space 2 using a camera 12 and the ranging sensor 13 or the like, and creating the space data 6 based on the measurement data. The terminal 1 can use the conversion parameters 7 to convert between coordinate systems relating to the representation of the measurement data and the space data 6.

The relation between the terminal coordinate systems (WA, WB) is roughly determined as follows. First, the relation of the rotations between the coordinate systems is obtained based on measuring the representations in each terminal coordinate systems (WA, WB) in two different specified directions in the real space. Next, based on the measurement of the relationship of the positions between the terminals 1, the relationship of the origin between each terminal coordinate system is determined. Conversion parameter 7 can be constituted by the parameter of the rotation and the parameter of the origin.

In the first embodiment, coordinate system pairing is performed for each pair of two terminals 1, with the terminal coordinate system of either one of the terminals 1 among a plurality of terminals 1 (e.g., the first terminal coordinate system WA) as a common coordinate system. As a result, at least one of the terminals 1, e.g., the first terminal 1A, creates and holds the conversion parameters 7. Thereafter, each terminal 1 measures the space 2 in a shared manner, and creates each partial space data described in each terminal coordinate system. Each terminal 1 may transmit/receive/exchange each partial space data as data described on the basis of a common coordinate system with each other terminal 1. The terminal 1 converts the partial space data between the description based on the terminal coordinate system of the terminal 1 of the own device and the description based on the common coordinate system using the conversion parameter 7. If the terminal coordinate system of the own device is a common coordinate system, this conversion is unnecessary. Then, the terminal 1 obtains the space data 6 in units of the space 2 by integration from the plurality of partial space data described in the unified terminal coordinate system. Thus, the plurality of terminals 1 can preferably display the same virtual image 22 at the same position 21 in the same space 2 by using the space data 6.

Even in the case of the terminal 1 provided with the non-transmissive display, the display position of the virtual image displayed on the display surface 11 can be shared with other terminals 1 while the terminal coordinate system of the terminal 1 is fixed to the real space.

### [Coordinate System]

In the first embodiment, a coordinate system serving as a reference for specifying a position, an orientation, or the like in the real space in each terminal 1 or space 2 is referred to as a world coordinate system. Each terminal 1 has a terminal coordinate system as its own world coordinate system. In FIG. 1, the first terminal 1A has a first terminal coordinate system WA, and the second terminal 1B has a second terminal coordinate system WB. Each terminal coordinate system is a coordinate system for recognizing and controlling the position and orientation of the terminal 1 (in other words, the posture, the state of rotation), the image display position, and the like. Since these terminal coordinate systems are set for each terminal 1, they are basically different coordinate systems, and do not coincide in the initial state. Further, the space 2 has a space coordinate system W1, as a world coordinate system representing the position and orientation of the space 2. In the first embodiment, the space coordinate system W1 is not used for measurement or creation of the space data 6. In the first embodiment, space data 6 is described in a terminal coordinate system. The first terminal coordinate system WA, the second terminal coordinate system WB, and the space coordinate system W1 are different coordinate systems. The origin and direction of each world coordinate system are fixed in real space, such as the Earth and the area or the like.

The first terminal coordinate system WA has an origin O_{A} and an axis X_{A}, an axis Y_{A}, and an axis Z_{A} as three axes perpendicular to each other. The second terminal coordinate system WB has an origin O_{B} and an axis X_{B}, an axis Y_{B}, and an axis Z_{B} as three axes that are perpendicular to each other. The space coordinate system W1 has an origin O₁ and an axis X₁, an axis Y₁, and an axis Z₁ as three axes perpendicular to each other. The origin O_{A}, O_{B} and the origin O₁ are fixed at predetermined positions in the real space, respectively. The position LA of the first terminal 1A in the first terminal coordinate system WA, and the position LB of the second terminal 1B in the second terminal coordinate system WB are defined in advance as, for example, the housing center position (FIG. 8).

When sharing the recognition of the space 2, the terminal 1 performs coordinate system pairing with other terminals 1. For example, the sharing terminals 1 (1A, 1B) perform coordinate system pairing with each other. At the time of coordinate system pairing, each terminal 1 measures and acquires predetermined quantities from each other (FIG. 8), and obtains relationships between the terminal coordinate systems (WA, WB) based on the quantities. Each terminal 1 calculates the conversion parameter 7 between the terminal coordinate systems (WA, WB) based on the relationships. In a state in which the coordinate system pairing is established, each terminal 1 can mutually convert positions and the like by using the conversion parameters 7. That is, each terminal 1 can convert the representation of the position or the like in the space data 6 created by the measurement of the space 2 into the representation in the common coordinate system. Each terminal 1 transmits and receives the space data 6 via the space data 6 described with reference to the common coordinate system. As a result, each terminal 1 can integrate the partial space data measured by each terminal 1 and create the space data 6 described in the unified terminal coordinate system. Incidentally, after the coordinate system pairing, each terminal 1 is not limited to perform the internal control of its own device by using the terminal coordinate system of its own device as a base, it is also possible to perform by using the terminal coordinate system of the partner as a base.

### [Space Recognition Method]

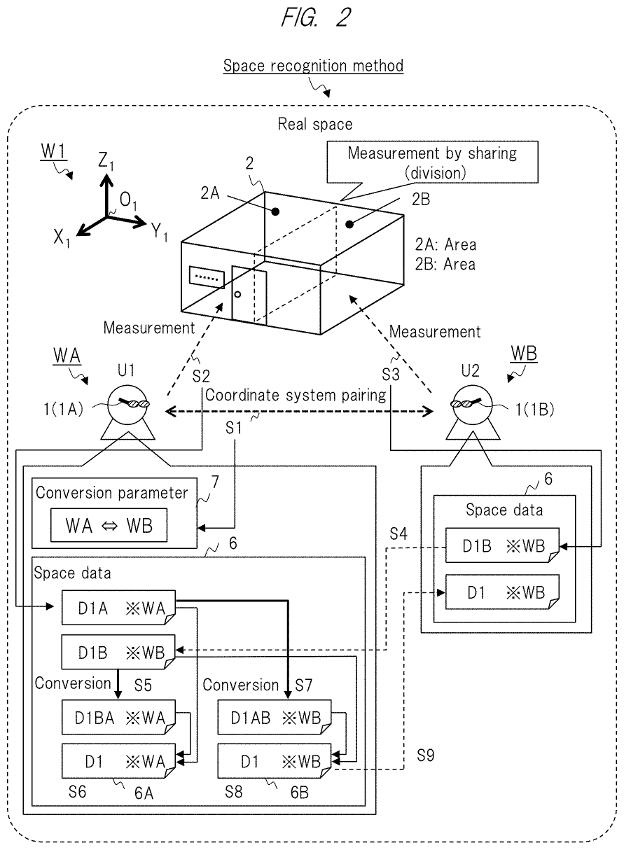

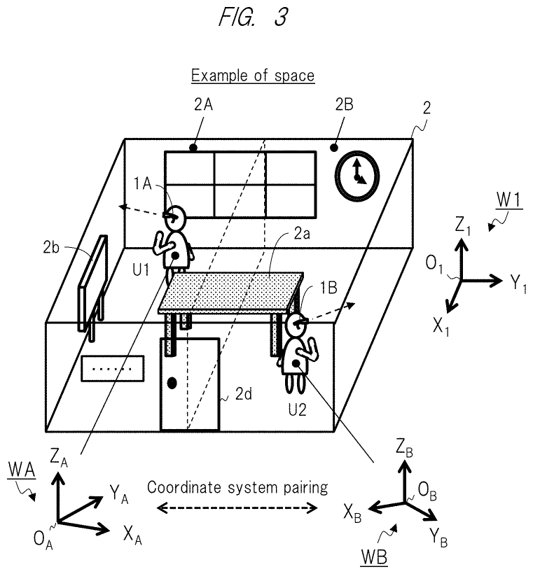

FIG. 2 shows an outline and a processing example of the space recognition method according to the first embodiment. The method includes steps S1-S9 as shown. In the case of FIG. 2, the first terminal 1A measures the area 2A and the second terminal 1B measures the area 2B as the sharing of the space 2 (as shown in FIG. 3 to be described later). In FIG. 2, the conversion parameters 7 are generated by the first terminal 1A to constitute space data 6 (6A, 6B) in units of the space 2, and the first terminal 1A provides the space data 6B to the second terminal 1B. Here, the second terminal 1B is the information processing device 9 in the basic configuration shown in FIG. 31, and the second terminal coordinate system WB corresponds to the common coordinate system WS.

In step S1, the first terminal 1A performs the coordinate system pairing with the second terminal 1B (FIG. 8 to be described later), thereby generating the conversion parameter 7 for the conversion between the first terminal coordinate system WA and the second terminal coordinate system WB and setting it to the own device.

In step S2, the first terminal 1A measures the area 2A based on the sharing, and creates the partial space data 6 (referred to as the partial space data D1A) described in the first terminal coordinate system WA. Note that the symbol * in the drawing indicates a coordinate system describing the space data. On the other hand, in S3, the second terminal 1B similarly measures the area 2B based on the sharing, and creates partial space data 6 described in the second terminal coordinate system WB (referred to as partial space data D1B). Steps S2, S3 can be executed in parallel at the same time.

In step S4, the first terminal 1A receives and acquires the partial space data D1B from the second terminal 1B. In step S5, the first terminal 1A converts the partial space data D1B into the partial space data 6 (the partial space data D1BA) described in the first terminal coordinate system WA using the conversion parameter 7.

In step S6, the first terminal 1A integrates the partial space data D1A and the partial space data D1BA into one, and obtains space data 6A (D1) in units of the space 2 described in the first terminal coordinate system WA. As a result, the first terminal 1A obtains the space data 6A (D1) in units of the space 2 even if only the area 2A is measured.

Furthermore, the method has the following steps. In step S7, the first terminal 1A converts the partial space data D1A into the partial space data 6 described in the second terminal coordinate system WB (referred to as the partial space data D1AB) using the conversion parameters 7. In step S8, the first terminal 1A integrates the partial space data D1B and the partial space data D1AB into one, and obtains space data 6B (D1) in units of space 2 described in the second terminal coordinate system WB. In step S9, the first terminal 1A transmits the space data 6B (D1) to the second terminal 1B. As a result, the second terminal 1B obtains the space data 6B (D1) in units of the space 2 even if only the area 2B is measured.

In the above manner, for the same space 2, the first terminal 1A acquires the space data 6A (D1) described in the first terminal coordinate system WA, and the second terminal 1B acquires the space data 6B (D1) described in the second terminal coordinate system WB. Therefore, it is possible to share the recognition of the space 2 between the terminals 1 (1A, 1B). For example, the first terminal 1A and the second terminal 1B can display the same virtual image 22 at the same position 21 in the space 2 (as will be described later with reference to FIG. 5). At this time, the first terminal 1A displays the virtual images 22 at the positions 21 described in the first terminal coordinate system WA based on the space data 6A (D1). The second terminal 1B displays a virtual picture 22 at a position 21 described in the second terminal coordinate system WB based on the space data 6B (D1).

The above-described methods can be similarly applied to the case where the conversion parameters 7 are generated by the second terminal 1B to configure the space data 6.

### [Space Example]

FIG. 3 shows an example of the configuration of the space 2 and an example in which the space 2 is shared and measured by the terminals 1 of a plurality of users. This space 2 is one room, e.g. a seventh conference room, in a building of, e.g. a company. In the space 2, there are arrangements such as a wall, a floor, a ceiling, and arrangements such as a door 2d, a desk 2a and a white board 2b and other devices. The arrangement is any real object that constitutes the space 2. The other space 2 may be a building such as a company or a store or an area, or may be a public space or the like.

The space data 6 describing the space 2 (in particular, the space shape data described later), is, for example, data of an arbitrary format representing the position, shape, and the like of the room. The space data 6 includes data representing a boundary of the space 2 and data of any object arranged in the space 2. The data representing the boundary of the space 2 includes, for example, data of arrangements such as a floor, a wall, a ceiling, and a door 2d which constitute a room. In some cases, there is no arrangement at the boundary. The data of the object in the space 2 includes, for example, data of a desk 2a, a whiteboard 2b, and the like arranged in the room. The space data 6 includes, for example, at least point group data, and is data having position coordinate information for each feature point in a certain terminal coordinate system. The space data 6 may be polygon data representing lines, planes, and the like in the space.

In this embodiment, the space 2, which is one room, is divided and measured in sharing manner by each terminal 1 (1A, 1B) of the users U1, U2, which are two users, to create the space data 6 of the space 2. The content of the sharing can be arbitrarily determined. For example, it is performed to consult between two users and share as shown in the figure. The sharing may be, as in the present example, to spatially divide the object space 2 into a plurality of areas (in other words, partial spaces). In this example, the space 2 is divided into left and right half areas with respect to the center in the left-right direction (axis Y₁ direction) in FIG. 3. The first terminal 1A is in charge of the left area 2A and the second terminal 1B is in charge of the right area 2B.

### [Example of Sharing Measurement]

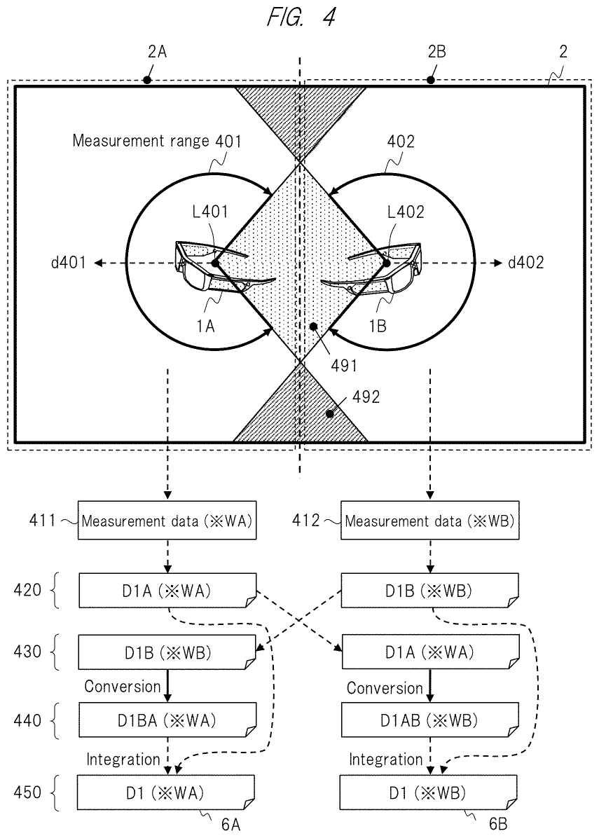

FIG. 4 shows an example of a measurement by sharing two users (U1, U2) at the terminals 1 (1A, 1B) in a bird's-eye view (e.g., X₁-Y₁ plane) of the space 2 of the room as shown in FIG. 3. FIG. 4 shows examples of states such as measuring ranges (401, 402) at certain positions (L401, L402) and orientations (d401, d402) of terminal 1 (1A, 1B), which are HMDs, at certain times. Measurement range is an example depending on the function of the ranging sensor 13 or the like provided in the HMD. Measurement range 401 shows a measurement range using, for example, a ranging sensor 13 in the position L401 and orientation d401 of the first terminal 1A. Measurement range 402 similarly indicates a measurement range in the position L402 and orientation d402 of the second terminal 1B.

When measuring the target space 2, it is not necessary to cover 100% of the area. A sufficient quantity of area in the space 2 may be measured according to the function of AR or the like or the necessity. Of the spaces 2, some areas that are not measured may occur, or areas that have been measured in duplicate by sharing may occur. In the example of FIG. 4, area 491 is an unmeasured area and area 492 is an overlappingly measured area. In advance, the ratio of the measurement of the space 2 or the shared area (for example, 90% or the like) may be set as a condition. For example, the first terminal 1A determines that the measurement is completed when the area 2A of the sharing is measured at a ratio equal to or higher than the ratio of the condition.

After pairing the coordinate system between the terminals 1 (1A, 1B), each terminal 1 measures each measurement range (401, 402) of the shared areas 2A, 2B, and obtains each measurement data. The first terminal 1A measures the measurement range 401 of the area 2A and obtains measurement data 411. The second terminal 1B measures the measurement area 402 of the area 2B and obtains measurement data 412. The measurement data is, for example, point group data obtained by the ranging sensor 13. Point group data is data with location, orientation, and distance, etc., for each point at a plurality of feature points around. Each terminal 1 creates the partial space data 420 from the measurement data. The first terminal 1A creates partial space data D1A described in the first terminal coordinate system WA from the measured data 411. The second terminal 1B creates partial space data D1B described in the second terminal coordinate system WB from the measured data 412.

In the example of FIG. 4, there is shown a case in which the first terminal 1A creates the space data 6A (D1) described in the first terminal coordinate system WA, and the second terminal 1B creates the space data 6B (D1) described in the second terminal coordinate system WB. Each terminal 1 transmits the partial space data 420 created by the own device to the other party's terminal 1. The first terminal 1A transmits the partial space data D1A to the second terminal 1B. The second terminal 1B transmits the partial space data D1B to the first terminal 1A.

Each terminal 1 converts the partial space data 430 obtained from the other terminal 1 into the partial space data 440 in its own terminal coordinate system using the conversion parameter 7. The first terminal 1A converts the partial space data D1B into the partial space data D1BA described in the first terminal coordinate system WA. The second terminal 1B converts the partial space data D1A into the partial space data D1AB described in the second terminal coordinate system WB.

Each terminal 1 integrates the partial space data 420 obtained by the own terminal 1 and the partial space data 440 obtained by the partner terminal into the space data 6 (450) in units of one space 2 in the unified terminal coordinate system. The first terminal 1A integrates the partial space data D1A and the partial space data D1BA into one to obtain the space data D1 (6A) described in the first terminal coordinate system WA. The second terminal 1B integrates the partial space data D1B and the partial space data D1AB into one to obtain the space data D1 (6B) described in the second terminal coordinate system WB. In the case of this example, which of the two terminals 1 corresponds to the information processing apparatus 9 of the basic configuration (FIG. 31) may be arbitrarily determined. The terminal coordinate system used in the transmission and reception of the space data 6 is a common coordinate system in the transmission and reception of the space data 6.

According to the above method, it is possible to realize the measurement and the acquisition of the space data more efficiently by shortening the time involved in the measurement and the acquisition of the space data as compared with the case where the space 2 is measured by the terminal 1 of one user.

It should be noted that, in the case where a space portion of the space 2 in which the other user is appeared viewing from the terminal 1 of one user and shade is created on the back side of the other user is generated, such a space portion can be measured by the terminal 1 of the other user, and it is more efficient to measure the space portion by the terminal 1 of the other user.

During the measurement, the user and the corresponding terminal 1 can also be moved appropriately to change the measurement range. Unmeasured area 491 shown can also be measured separately by including in the measurement range from other positions.

As a more sophisticated method of sharing, either terminal 1 may automatically judge and determine the sharing. For example, each terminal 1 judges, based on a camera image or the like, the schematic position and orientation of its own device in the room, the presence or absence of the imprinting of another user or other machine, its position and orientation, and the like. For example, when the second user U2 and the second terminal 1B are not appeared in the camera image, the first terminal 1A selects the area and range in the orientation at that time as the area and range to be shared by the first terminal 1A.

### [Example of Use]

FIG. 5 shows an example of use of the space 2 using the space data 6 between the terminals 1 (1A, 1B) of two users (U1, U2) sharing the recognition of the space 2 as shown in FIG. 3. The first terminal 1A and the second terminal 1B display the same virtual image 22 at the same position 21 in the space 2 by the AR function using the space data 6 in the state of the coordinate system pairing of the first terminal coordinate system WA and the second terminal coordinate system WB. At this time, the first terminal 1A displays the virtual image 22 at the position 21 in the first terminal coordinate system WA on the display surface 11, and the second terminal 1B displays the virtual image 22 at the position 21 in the second terminal coordinate system WB on the display surface 11. One of the terminals 1, for example, the first terminal 1A designates the position 21 and the virtual image 22 to be displayed, and transmits the information of the position 21 and the like to the second terminal 1B. At that time, the first terminal 1A or the second coordinate system WB converts the position 21 in the first terminal coordinate system WA to the position 21 in the second terminal coordinate system WB using the conversion parameter 7. Each terminal 1 can quickly and accurately display the virtual image 22 at a position 21 corresponding to the position, shape, or the like of the arrangement of the space 2 represented by the space data 6. For example, each terminal 1 can arrange and display the virtual image 22 in accordance with the position 21 of the center of the top surface of the desk 2a designated by the user U1. The user U1 and the user U2 can perform operations and communication while viewing the same virtual image 22.

### [Information Terminal Device (HMD)]

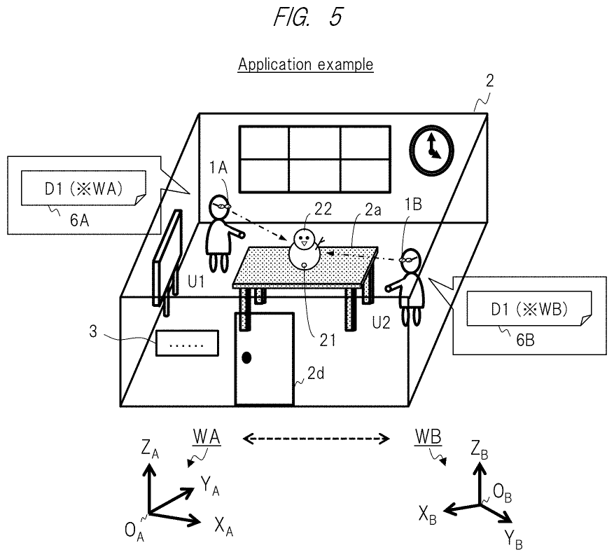

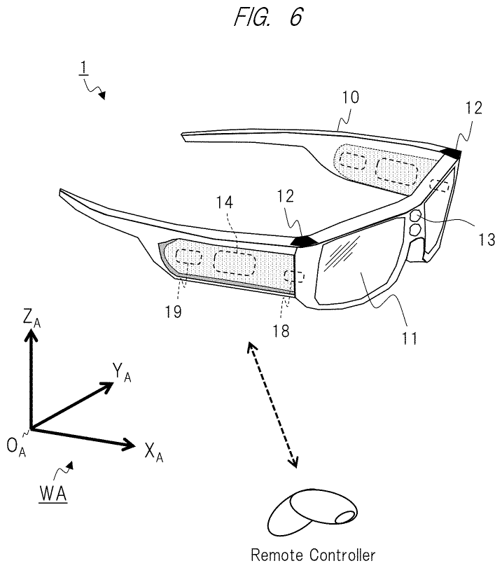

FIG. 6 shows an example of the external structure of an HMD as an example of the terminal 1. The HMD includes a display device including a display surface 11 in a spectacle-shaped housing 10. The display device is, for example, a transmission type display device, and a real image of the outside is transmitted through the display surface 11, and an image is superimposed on the real image. On the housing 10, the controller, the camera 12, the ranging sensor 13, the other sensor unit 14, and the like are mounted.

The camera 12 has, for example, two cameras disposed on the left and right sides of the housing 10, and captures an image by taking a range including the front of the HMD. The ranging sensor 13 is a sensor for measuring the distance between the HMD and the external object. The ranging sensor 13 may use a TOF (Time Of Flight) type sensor, or may use a stereo camera or other type of systems. The sensor unit 14 includes a group of sensors for detecting the state of the position and orientation of the HMD. On the left and right sides of the housing 10, there are provided an audio input device 18 including a microphone, an audio output device 19 including a speaker and an earphone terminal, and the like.

An operating device such as a remote controller may be attached to the terminal 1. In this case, the HMD performs, for example, short-range wireless communication with the operating device. The user can input an instruction relating to the function of the HMD, move the cursor on the display surface 11, and the like by operating the operating device by hand. The HMD may communicate with an external smartphone, PC, or the like to perform cooperation. For example, the HMD may receive AR image data from an application of a smartphone.

The terminal 1 includes an application program or the like that displays a virtual image such as an AR on the display surface 11 for work assistance or entertainment. For example, the terminal 1 generates a virtual image 22 (FIG. 1) for work support by processing an application for work support, and arranges and displays the virtual image 22 at a predetermined position 21 in the vicinity of the work object in the space 2 on the display surface 11.

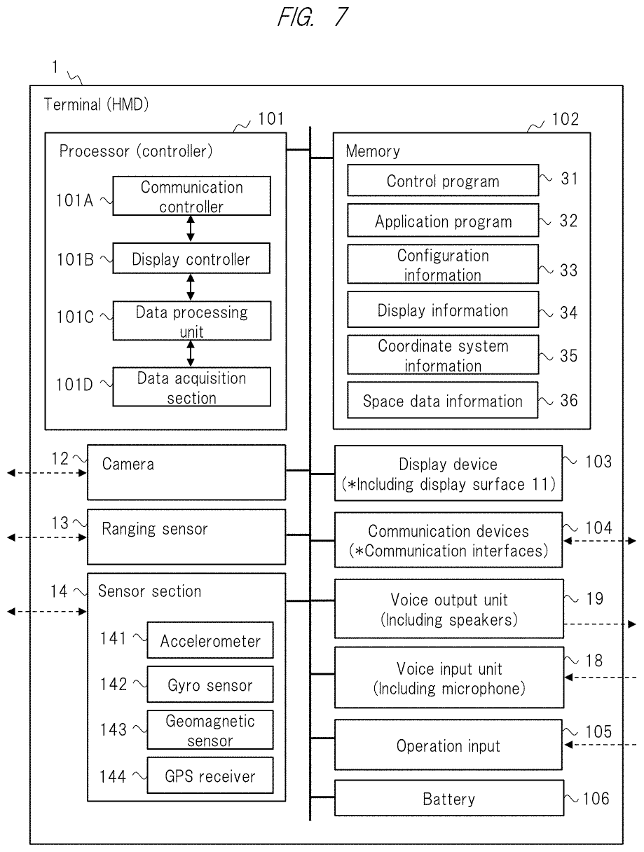

FIG. 7 shows an example of a functional block configuration of the terminal 1 (HMD) of FIG. 6. The terminal 1 includes a processor 101, a memory 102, a camera 12, a ranging sensor 13, a sensor unit 14, a display device 103 including a display surface 11, a communication device 104, a voice input device 18 including a microphone, a voice output device 19 including a speaker or the like, an operation input unit 105, and a battery 106 or the like. These elements are connected to each other through a bus or the like.

The processor 101 includes a CPU, a ROM, a RAM, and the like, and configures a controller of the HMD. The processor 101 executes processing in accordance with the control program 31 and the application program 32 of the memory 102 to realize functions such as an OS, a middleware, and an application and other functions. The memory 102 is composed of a non-volatile storage device or the like and stores various data and information handled by the processor 101 or the like. The memory 102 also stores, as temporary information, an image acquired by the camera 12 or the like, detected information, and the like.

The camera 12 acquires an image by converting the light incident from the lens into an electrical signal by the image pickup device. The ranging sensor 13, for example, when using a TOF sensor, calculates the distance to the object from the time until the light emitted to the outside comes back after hitting the object. The sensor unit 14 includes, for example, an acceleration sensor 141, a gyro sensor (angular velocity sensor) 142, a geomagnetic sensor 143, and a GPS receiver 144. The sensor unit 14, using the detected information of these sensors, detects the position, orientation, the state of the movement or the like of the HMD. The HMD is not limited thereto, may be provided with an illuminance sensor, a proximity sensor, an atmospheric pressure sensor or the like.

The display device 103 includes a display driving circuit and the display surface 11, and displays a virtual image or the like on the display surface 11 based on the image data of the display information 34. Note that the display device 103 is not limited to a transmissive display device, and may be a non-transmissive display device or the like.

The communication device 104 includes a communication processing circuit, an antenna, and the like corresponding to various predetermined communication interfaces. Examples of communication interfaces include mobile networks, Wi-Fi (registered trademark), Bluetooth (registered trademark), infra-red or the like. The communication device 104 performs wireless communication processing or the like between the other terminal 1 and the access point 23 (FIG. 1). The communication device 104 also performs short-range communication processing or the like with the operating device.

The voice input device 18 converts the input voice from the microphone into voice data. The sound output device 19 outputs sound from a speaker or the like based on the sound data. The voice input device may include a voice recognition function. The voice output device may include a voice synthesis function. The operation input unit 105 is a portion for receiving an operation input to the HMD, for example, power-on/off or volume adjustment or the like, and is composed of a hardware button, a touch sensor or the like. The battery 106 supplies power to each part.

The controller by the processor 101 includes a communication control unit 101A, a display control unit 101B, a data processing unit 101C, and a data acquiring unit 101D as examples of the configuration of functional blocks realized by processing.

The memory 102 stores a control program 31, an application program 32, setting information 33, display information 34, coordinate system information 35, space data information 36, and the like. The control program 31 is a program for realizing control including a space recognition function. The application program 32 is a program that realizes a function such as an AR that uses the space data 6. The setting information 33 includes system setting information and user setting information related to each function. The display information 34 includes image data and position coordinate information for displaying an image such as the virtual image 22 on the display surface 11.

The coordinate system information 35 is management information related to the space recognition function. The coordinate system information 35 includes information of the first terminal coordinate system WA of the own device, information of the second terminal coordinate system WB of the other device, various quantity data of the own device side and various quantity data of the other device side (FIG. 8), and the conversion parameters 7 (FIG. 1 and the like) when sharing between two users as shown in FIG. 3, for example.

The space data information 36 is the information corresponding to the space data 6 of FIG. 1 and the like, and is the information created and held by the terminal 1. The terminal 1 may hold the space data 6 relating to each space 2 as a library inside the own device. The terminal 1 may acquire and hold the space data 6 from another terminal 1. As will be described later, the terminal 1 may acquire the space data 6 held and provided by an external server or the like.

The communication control unit 101A controls a communication process using the communication device 104 when communicating with another terminal 1 or the like. The display control unit 101B controls the display of the virtual images 22 and the like on the display surface 11 of the display devices 103 using the display data 34.

The data processing unit 101C reads and writes the coordinate system information 35, and performs processing for managing the terminal coordinate system of the data processing unit itself, processing for pairing the coordinate system with the terminal coordinate system of the partner, processing for converting between the coordinate systems using the conversion parameters 7, and the like. At the time of the coordinate system pairing, the data processing unit 101C performs processing for measuring various quantity data on its own device side, processing for acquiring various quantity data on the other device side, processing for generating the conversion parameter 7, and the like.

The data acquiring unit 101D acquires the detected data from various sensors such as the camera 12, the ranging sensor 13, and the sensor unit 14. At the time of coordinate system pairing, the data acquiring unit 101D measures the quantity data of its own device side in accordance with the control from the data processing unit 101C.

### [Coordinate System Pairing]

Next, the details of the coordinate system pairing will be described. FIG. 8 is an explanatory diagram illustrating the coordinate system pairing between the first terminal coordinate system WA of the first terminal 1A and the second terminal coordinate system WB of the second terminal 1B in FIG. 1, and shows the relationships between the coordinate systems and various quantities. Hereinafter, space recognition sharing by coordinate system pairing between the first terminal coordinate system WA and the second terminal coordinate system WB between these two terminals 1 will be described.

In the example of FIG. 8, unlike the position of the origin O_{A} of the first terminal coordinate system WA and the position LA of the first terminal 1A, the position of the origin O_{B} of the second terminal coordinate system WB differs from the position LB of the second terminal 1B, but the present invention is not limited to this. These positions may coincide, and the same is applicable in this case. In the following, the relationship also between the coordinate systems will be described in the general case where the origin of the world coordinate system and the position of the terminal 1 do not coincide with each other.

For example, when the first terminal 1A performs space recognition sharing with the second terminal 1B, the first terminal 1A performs coordinate system pairing as an operation of sharing world coordinate system information with each other by using those terminals as one pair. The two terminals 1 (1A, 1B) may perform one coordinate system pairing once. Even when there are three or more terminals 1, the coordinate system pairing may be performed similarly for each pair.

At the time of coordinate system pairing, each terminal 1 (1A, 1B) measures predetermined quantities in each terminal coordinate system (WA, WB), and exchanges quantity data with the other terminal 1. The first terminal 1A measures a specific-direction vector N_{A}, an inter-terminal vector P_{BA}, and a coordinate-value d_{A} as the quantities 801 measured by the own device. The first terminal 1A transmits the data of those quantities 801 to the second terminal 1B. The second terminal 1B measures a specific-direction vector N_{B}, an inter-terminal vector P_{AB}, and a coordinate-value d_{B} as the quantities 802 measured by the own device. The second terminal 1B transmits the data of those quantities 802 to the first terminal 1A.

Each terminal 1 can determine the relationship between the terminal coordinate system of the pair based on the various quantity data measured by its own device and the various quantity data obtained from the partner device, and from the relationship, it is possible to calculate the conversion parameter 7 for the conversion between the terminal coordinate systems. Thus, between the terminals 1, using the conversion parameter 7, the sharing of the world coordinate system information can be performed by associating each terminal coordinate system.

When only one of the terminals 1 in the coordinate system pairing, for example, only the first terminal 1A performs conversion between the coordinate systems, only the first terminal 1A needs to acquire the quantities 801 on the own device side and the quantities 802 on the other device side to generate the conversion parameter 7. In this case, the quantities 801 need not be transmitted from the first terminal 1A to the second terminal 1B. The first terminal 1A may transmit the generated conversion parameter 7 to the second terminal 1B. In this case, the second terminal 1B side can also perform conversion.

In the first embodiment, information of the following three elements is included as various quantities at the time of coordinate system pairing. The quantities include a specific direction vector as first information, an inter-terminal vector as second information, and a world coordinate value as third information.

(1) Regarding a specific direction vector: Each terminal 1 uses a specific direction vector as information about a specific direction in the real space in the world coordinate system. Two distinct directional vectors (N_{A}, N_{B}, M_{A}, M_{B}) are used to obtain the relation of rotation between coordinate systems. The specific direction vector N_{A} is a representation of the first direction vector in the first terminal 1A and the unit direction vector is n_{A}. The specific direction vector N_{B} is a representation of the first direction vector in the second terminal 1B and the unit direction vector is n_{B}. The specific direction vector M_{A} is a representation of the second direction vector in the first terminal 1A and the unit direction vector is m_{A}. The specific direction vector M_{B} is a representation of the second direction vector in the second terminal 1B and the unit direction vector is m_{B}.

In the first embodiment, in particular, a vertically downward direction is used as one specific direction (first specific direction), and a later-described inter-terminal vector is used as another specific direction (second specific direction). In the illustrative example of FIG. 8, a vertically downward specific direction vector N_{A}, N_{B} is used as the first specific direction. The specific direction vector N_{A} is a vertical downward direction vector of the first terminal 1A and the unit direction vector is n_{A}. The specific direction vector N_{B} is a vertical downward direction vector of the second terminal 1B, and the unit direction vector is n_{B}.

The vertical downward direction can be measured as the direction of the gravitational acceleration, for example, using a three-axis acceleration sensor which is an acceleration sensor 141 provided in the terminal 1 (FIG. 7). Alternatively, in the setting of the world coordinate system (WA, WB), the vertical down direction may be set as the negative direction of the Z-axis (Z_{A}, Z_{B}). In any case, the vertical downward direction, which is this specific direction, does not change in the world coordinate system, it is not necessary to measure each time for the coordinate system pairing.

(2) Regarding an inter-terminal vector: Each terminal 1 uses information of vectors (i.e., directions and distances) between terminal positions (LA, LB) as information representing positional relationships from one terminal 1 (e.g., the first terminal 1A) to the other terminal 1 (e.g., the second terminal 1B). This information is referred to as the “inter-terminal vector”. In the example of FIG. 8, an inter-terminal vectors P_{BA}, P_{AB} are used. The inter-terminal vector P_{BA} is a vector representing the positional relation viewed from the position LA to the position LB of the second terminal 1B taking the first terminal 1A as a standard. The inter-terminal vector P_{AB} is a vector representing the positional relation viewed from the position LB to the position LA of the first terminal 1A taking the second terminal 1B as a standard. The vector representation in the first terminal coordinate system WA from the first terminal 1A to the second terminal 1B is P_{BA}, and the vector representation in the second terminal coordinate system WB from the second terminal 1B to the first terminal 1A is P_{AB}.

The inter-terminal vector includes information about another specific direction (second specific direction) in the real space for determining the orientation relationship between the world coordinate systems. Here, there is a correspondence relationship between the specified directional vector (M_{A}, M_{B}) and the inter-terminal vector (P_{BA}, P_{AB}) as follows.

P_{BA}=M_{A}

P_{AB}=−M_{B}

During the coordinate system pairing, each terminal 1 measures the inter-terminal vector to the other terminal 1, for example, using a ranging sensor 13 or a camera 12 of the stereo type such as shown in FIG. 1. The distance measurement of the positional relationship between the terminals 1 may be performed in the following manner in detail. For example, the ranging sensor 13 of the first terminal 1A measures the distance between the second terminal 1B visible in front. At this time, the first terminal 1A, for recognizing the second terminal 1B, may be measured the shape of the housing of the second terminal 1B from the image of the camera 12, and a predetermined mark or the like formed in the housing of the second terminal 1B may be measured as a feature point.

(3) Regarding world coordinate system: Each terminal 1 uses information of a coordinate value representing a position in the world coordinate system. In the example of FIG. 8, the coordinate value d_{A} in the first terminal coordinate system WA and the coordinate value d_{B} in the second terminal coordinate system WB are used as the world coordinate value. The coordinate value in the first terminal coordinate system WA with respect to the position LA of the first terminal 1A is d_{A}=(x_{A}, y_{A}, z_{A}). The coordinate value in the second terminal coordinate system WB for the position LB of the second terminal 1B is d_{B}=(x_{B}, y_{B}, z_{B}). These coordinate values are determined in accordance with the setting of the world coordinate system. The terminal position vector V_{A} is a vector from the origin O_{A} to the position LA. The terminal position vector V_{B} is a vector from the origin O_{B} to the position LB.

In FIG. 8, the vector F_{A} is a vector representing the position of the second terminal 1B in the first terminal coordinate system WA of the first terminal 1A corresponding to the terminal position information, and corresponds to a vector formed by combining the coordinate value d_{A} (vector V_{A}) of the first terminal 1A and the inter-terminal vector P_{BA}. The vector F_{B} is a vector representing the position of the first terminal 1A in the second terminal coordinate system WB of the second terminal 1B, and corresponds to a vector obtained by combining the coordinate value d_{B} (vector V_{B}) of the second terminal 1B and the inter-terminal vector P_{AB}. The position vector G_{A} is a vector of the position 21 in the first terminal coordinate system WA, and the position coordinate value r_{A} is a coordinate value of the position 21. The position vector G_{B} is a vector of the position 21 in the second terminal coordinate system WB, and the position coordinate value r_{B} is a coordinate value of the position 21. The inter-origin vector o_{BA} is a vector from the origin O_{A} of the first terminal coordinate system WA to the origin O_{B} of the second terminal coordinate system WB, and the inter-origin vector o_{AB} is a vector from the origin O_{B} of the second terminal coordinate system WB to the origin O_{A} of the first terminal coordinate system WA. A vector E_{A} is a vector for viewing the position 21 from the position LA corresponding to the viewpoint of the user U1. A vector E_{B} is a vector for viewing the position 21 from the position LB corresponding to the viewpoint of the user U2.

### [Conversion Parameters]

By the coordinate system pairing, the relation of the world coordinate system (WA, WB) between the terminals 1 (1A, 1B) can be known, and the positions and orientations can be converted from each other. That is, it is possible to perform a conversion for matching the second terminal coordinate system WB to the first terminal coordinate system WA, or vice versa. The conversion between the world coordinate systems is represented by the predetermined conversion parameter 7. The conversion parameter 7 is a parameter for a conversion of the direction of the coordinate system (in other words, rotation) and a calculation of the difference between the origin of the coordinate system.

For example, when the coordinate system conversion can be performed at the first terminal 1A, the first terminal 1A calculates the relation between the terminal coordinate system (WA, WB) from the quantities 801 of the own device side and the quantity 802 of the other device side, generates the conversion parameter 7, and sets it to the own device. The same can be applied to the second terminal 1B. The conversion parameter 7 includes a conversion parameter 71 for converting a position in the first terminal coordinate system WA to a position in the second terminal coordinate system WB and the like, and a conversion parameter 72 for converting a position in the second terminal coordinate system WB to a position in the first terminal coordinate system WA and the like. These conversions are inverse conversions of each other. At least one terminal 1 may hold the conversion parameter 7, and both terminals 1 may hold the same conversion parameters 7.

### [Position Conversion]

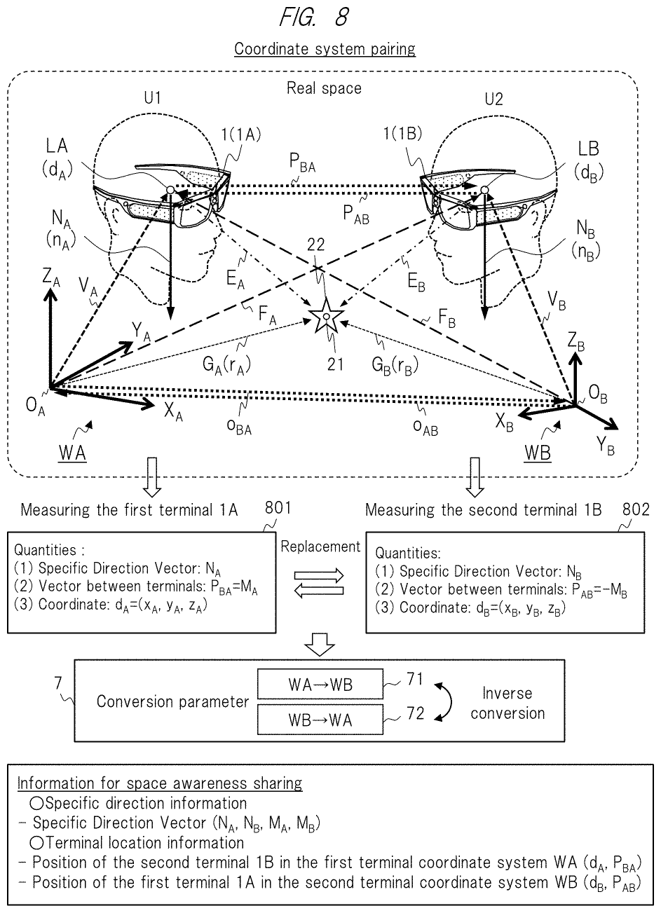

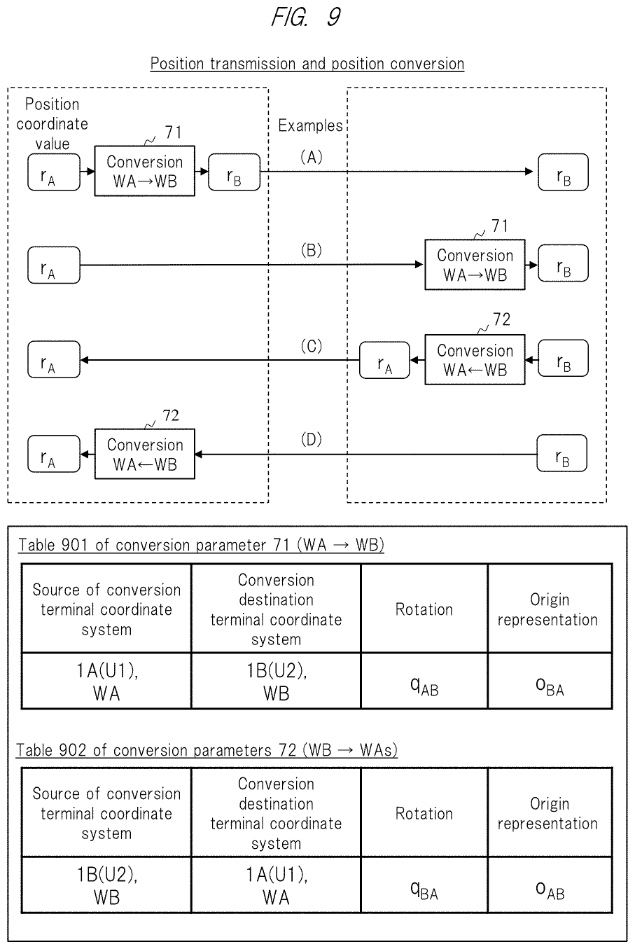

FIG. 9 shows an exemplary configuration of position transmission and coordinate system conversion between two terminals 1 (1A, 1B) after coordinate system pairing. Four examples are shown as (A)-(D). The same position 21 (FIG. 8) in the space 2 can be specified and shared between the terminals 1 (1A, 1B) by using the conversion parameters 7. One terminal 1 transmits the designated information of the position 21 and the data of the virtual image 22 to be displayed to the other terminal 1. One or the other terminal 1 uses the conversion parameters 7 to convert the position 21 between the coordinate systems.

(A) shows a first example. The first terminal 1A converts the position coordinate value r_{A} that is the position in the first terminal coordinate system WA (for example, the position 21 of the display target of the virtual image 22) to the position in the second terminal coordinate system WB (position coordinate value r_{B}) using the conversion parameter 71, and transmits the converted position coordinate value to the second terminal 1B.

(B) shows a second example. The first terminal 1A transmits the position coordinate value r_{A} that is a position in the first terminal coordinate system WA to the second terminal 1B, and the second terminal 1B converts the received position coordinate value r_{A} into the position coordinate value r_{B} in the second terminal coordinate system WB using the conversion parameter 71.

(C) shows a third example. The second terminal 1B converts the position coordinate value r_{B}, which is a position in the second terminal coordinate system WB, into the position coordinate value r_{A} in the first terminal coordinate system WA using the conversion parameter 72, and transmits the result to the first terminal 1A.

(D) shows a fourth example. The second terminal 1B transmits the position coordinate value r_{B} in the second terminal coordinate system WB to the first terminal 1A, and the first terminal 1A converts the received position coordinate value r_{B} into the position coordinate value r_{A} in the first terminal coordinate system WA using the conversion parameter 72.

As described above, for example, when the position is transmitted from the first terminal 1A to the second terminal 1B, a conversion may be performed by the method (A) or (B), and when the position is transmitted from the second terminal 1B to the first terminal 1A, a conversion may be performed by the method (C) or (D). In terms of correspondence with the basic configuration (FIG. 31), (A) and (D) are cases where the second terminal coordinate system becomes a common coordinate system, and (B) and (C) are cases where the first terminal coordinate system becomes a common coordinate system.

The lower part of FIG. 9 shows an example of the table configuration of the conversion parameter 7. The table 901 of the conversion parameters 71 has, as items, a conversion source terminal coordinate system, a conversion destination terminal coordinate system, a rotation, and an origin representation. The “conversion source terminal coordinate system” item stores the identification information of the conversion source terminal 1 (the corresponding user in parentheses) and the identification information of the terminal coordinate system included in the terminal 1. The “conversion end terminal coordinate system” item stores the identification information of the conversion destination terminal 1 (the corresponding user in parentheses) and the identification information of the terminal coordinate system included in the terminal 1. The “Rotate” item stores information on the representation of the rotation between those terminal coordinate systems. The “Origin Representation” item stores a representation of the difference in origin between the terminal coordinate systems. For example, the first row of the table 901 of the conversion parameter 71 includes a rotation (q_{AB}) for conversion from the first terminal coordinate system WA of the first terminal 1A to the second terminal coordinate system WB of the second terminal 1B, and a representation (o_{A}) of the origin of the second terminal coordinate system WB as viewed in the first terminal coordinate system WA.

### [Process Flow]

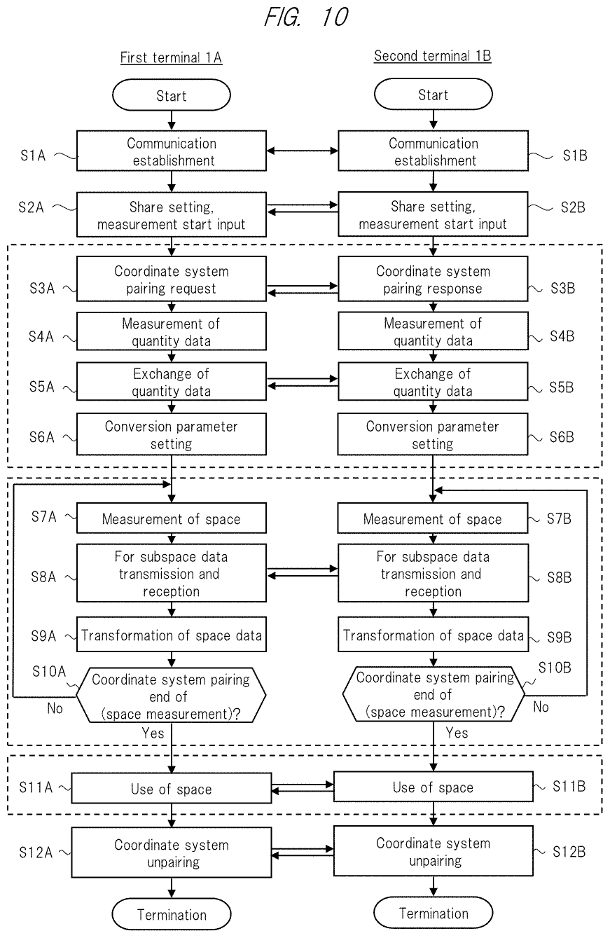

FIG. 10 shows an exemplary process flow when the space 2 is shared and measured between two terminals 1 (1A, 1B) as shown in FIG. 3, and one piece of the space data 6 is obtained. FIG. 10 has a flow (steps S1A to S12A) of the first terminal 1A and a flow (steps S1B to S12B) of the second terminal 1B.

In the steps S1A and S1B, a radio communication connection related to space recognition sharing is established between the first terminal 1A and the second terminal 1B through the process of the communication device 107 of FIG. 7.

In the steps S2A and S2B, the user performs an input operation for starting the measurement of the space 2 on the terminal 1, which is an HMD. For example, the user U1 inputs a measurement start instruction to the first terminal 1A, and the user U2 inputs a measurement start instruction to the second terminal 1B. It is to be noted that a communication related to the starting of measurement may be performed between the terminals 1 (1A, 1B). Further, for example, the terminal 1 may display a guide image relating to the operation of starting or ending the measurement on the display surface 11. The user performs an input operation for starting or ending the measurement in accordance with the display. The input operation may be a hardware button operation, an operation by voice recognition, or an operation by detection of a predetermined gesture such as movement of a finger or the like. As another method, the terminal 1 may control the start and end of the measurement by setting in advance or automatic determination.

Further, in the step S2A, S2B, the sharing of the area of the space 2 and the measuring range as shown in FIGS. 3 and 4 may be set. The terminal 1 may display an image related to the sharing setting on the display surface 11. The user operates the settings according to the image. Based on the step S2A, S2B, the respective terminals 1 start subsequent steps.

Steps S3A to S6A and S3B to S6B are steps for performing coordinate system pairing. The method of the first embodiment is a method of measuring the space 2 after the coordinate system pairing. Therefore, the measurement start instruction of the steps S2A, S2B is, in other words, the measurement start instruction of the coordinate system pairing.

In steps S3A, S3B, request for coordinate system pairing is transmitted from one terminal 1 to the other terminal 1. For example, the first terminal 1A transmits a coordinate system pairing request to the second terminal 1B. The second terminal 1B receives the coordinate system pairing request, and when accepting the request, transmits a coordinate system pairing response indicating acceptance of the request to the first terminal 1A. In step S3A, S3B, each terminal 1 may display image for guiding the coordinate system pairing on the display surface 11 (which will be described later with reference to FIG. 11).

In steps S4A, S4B, the first terminal 1A and the second terminal 1B are matched in their timing with each other to measure the quantities for coordinate system pairing (FIG. 8). The first terminal 1A measures quantities 801 and the second terminal 1B measures quantities 802.

In steps S5A, S5B, the first terminal 1A and the second terminal 1B mutually transmit the quantity data on the own device side to the other device side, thereby exchanging the quantity data. The first terminal 1A acquires the quantities 802 from the second terminal 1B, and the second terminal 1B acquires the quantities 801 from the first terminal 1A.

In steps S6A, S6B, the first terminal 1A and the second terminal 1B generate the conversion parameters 7, respectively, to set the own device. The first terminal 1A generates a conversion parameter 7 (e.g., both the conversion parameters 71 and 72 in FIG. 9) using the quantities 801 of the own device and the quantities 802 of the other device side to set the own device. The second terminal 1B generates a conversion parameter 7 (e.g., both the conversion parameters 71 and 72 in FIG. 9) using the quantities 802 of the own device side and the quantities 801 of the other device side to set the own device. This establishes the state of the coordinate system pairing.

After the coordinate system pairing is established, a measurement-start instruction of steps S2A, S2B may be inputted.

After the coordinate system pairing is established up to the steps S6A, S6B, in the loops after the steps S7A, S7B, the terminals 1 measure the area of the space 2 due to the sharing (FIGS. 3 and 4). In step S7A, the first terminal 1A measures the area 2A using the ranging sensor 13 or the like to obtain the measured data 411. In S7B, the second terminal 1B measures the area 2B using the ranging sensor 13 or the like to obtain the measured data 412.

In steps S8A, S8B, each terminal 1 constructs partial space data based on the measured data, and transmits the partial space data to each other's terminals 1 (FIG. 4). The first terminal 1A obtains partial space data D1A on its own device side and partial space data D1B from the other device side. The second terminal 1B obtains partial space data D1B on its own device side and partial space data D1A from the other device side.

In steps S9A, S9B, each terminal 1 converts the partial space data described in the terminal coordinate system of the other side into the partial space data described in the terminal coordinate system of the own device side using the conversion parameters 7 as required (FIG. 4). For example, as shown in (D) of FIG. 9, the first terminal 1A converts the partial space data D1B into the partial space data D1BA using the conversion parameter 72. As shown in (B) of FIG. 9, the second terminal 1B converts the partial space data D1A into the partial space data D1AB using the conversion parameter 71. In addition, each terminal 1 integrates the partial space data obtained on its own device side and the partial space data obtained on the other device side into one to obtain the space data 6 in units of the space 2 (FIG. 4). For example, the first terminal 1A obtains the space data 6A (D1) from the partial space data D1A and the partial space data D1BA. The second terminal 1B obtains the space data 6B D1 from the partial space data D1B and the partial space data D1AB. Note that, although the present exemplary embodiment has been described in which both terminals 1 create their respective space data 6 (6A, 6B) in parallel at the same time, the present invention is not limited to this, and the space data 6 created by one of the terminals 1 may be transmitted to the other terminal 1.

In steps S10A, S10B, each terminal 1 judges whether or not to finish the space measurement in the coordinate system pairing state. At this time, the user may input an instruction to end the measurement to the terminal 1, or the terminal 1 may end the measurement by automatic determination. For example, the terminal 1 may be determined that the measurement end of the own device, when it is determined that a predetermined rate or more of the area of the space 2 or sharing of the object has been measured or created, based on the measurement data or space data or the like. The rate is a variable setpoint. The terminal 1 proceeds to the following step when it is determined that the measurement is completed (Yes), and returns to the steps S7A, S7B when it is determined that the measurement is not completed (No), and repeats the same process.

In steps S11A, S11B, each terminal 1 uses the space 2 while sharing the recognition of the space 2 with the other terminal 1 by using the created space data 6. It should be noted that steps S11A, S11B can be omitted when the creation of the space data 6 is the object of the present method. The use of the space 2 typically includes displaying the same virtual image 22 at a desired same position 21 in the space 2 by using an AR function between the terminals 1 (1A, 1B), and performing an operation or the like (FIG. 5).

In steps S12A, S12B, each terminal 1 cancels the state of the coordinate system pairing. For example, when the use of the space 2 is temporary, each terminal 1 may delete the conversion parameter 7 or may delete the space data 6. The present method is not limited to this, and each terminal 1 may maintain the state of the coordinate system pairing thereafter. That is, each terminal 1 may continue to retain the conversion parameters 7 and the space data 6 thereafter. In such cases, steps S12A, S12B can be omitted. For example, each terminal 1 is possible to omit the processing such as measurement again or the like when subsequently reusing the same space 2, by holding the conversion parameter 7 and the space data 6 within its own device.

### [Example of Guide Display]

FIG. 11 shows examples in which images of graphical user interfaces (GUIs) for guides and the like are displayed on the display surface 11 of the terminal 1 during the coordinate system pairing between the terminals 1 (steps S3A, S3B in FIG. 10 and the like). The example of FIG. 11 is an example of the display surface 11 of the first terminal 1A of the user U1, and the second terminal 1B of the user U2 is visible. The first terminal 1A recognizes other users and the terminal 1 based on, for example, images of the cameras 12 or the like. For example, the first terminal 1A superimposes and displays an image 1101 in accordance with the position at which the second terminal 1B is recognized. The image 1101 is a virtual image such as a mark representing the presence and position of the second terminal 1B. In addition, the first terminal 1A displays an image 1102 for confirming whether or not to perform coordinate system pairing with the second terminal 1B of the recognized user U2. The image 1102 is a message image such as “Do you want to pair with user U2?YES/NO”. User U1 performs a selection operation of YES/NO to the image 1102, accordingly, the first terminal 1A determines whether or not to execute the coordinate system pairing with the second terminal 1B, and controls the start.

Further, the first terminal 1A displays an image 1103 when measuring the quantities 801 in the step S4A. The image 1103 is, for example, a message image such as “Under pairing. Do not move as much as possible”. During direct coordinate system pairing between the terminals 1, by making the state as stationary as possible to each other, various quantities can be measured with high accuracy. Therefore, the output of the image 1103 for such a guide is effective.

### [Coordinate Conversion]

The details of the coordinate conversion are described in detail below. First, the notation for explaining the relationship of the coordinate system will be summarized. In an embodiment, the coordinate system is unified to the right hand system and a normalized quaternion is used to represent the rotation of the coordinate system. Normalized quaternion is a quaternion with a norm of 1, and can represent rotation about an axis. The rotation of an arbitrary coordinate system can be represented by such a normalized quaternion. The normalized quaternion q representing the rotation of the angle η, with the unit vector (n_{X}, n_{Y}, n_{Z}) as the rotation axis is given by Equation 1 below. i, j, k are units in quaternions. The clockwise rotation when the unit vector (n_{X}, n_{Y}, n_{Z}) is oriented is the forward rotation.

q=cos(η/2)+n_{X} sin(η/2)i+n_{Y} sin(η/2)j+n_{Z} sin(η/2)k Equation 1:

The real part of the quaternion q is represented by Sc(q). Let q* be the conjugate quaternion of the quaternion q. The operating device that normalizes the norm of the quaternion q to 1 is defined by [•]. Assuming that the quaternion q is an arbitrary quaternion, Equation 2 is the definition of the [⋅]. The denominator on the right side of Equation 2 is the norm of the quaternion q.

[q]=q/(qq*)^{1/2} Equation 2:

Next, the quaternion p representing the coordinate point or vector (p_{X}, p_{Y}, p_{Z}) is defined by Equation 3.

p=p_{X}i+p_{Y}j+p_{Z}k Equation 3:

In this specification, unless otherwise noted, the symbols representing the coordinate points and vectors that are not component display are assumed to be quaternion representations. It is also assumed that the symbol representing rotation is a normalized quaternion.

The projection operating device of the vector into the plane perpendicular to the direction of the unit vector n is assumed to be P_{T}(n). The projection of the vector p is represented by Equation 4.

P_{T}(n)p=p+nSc(np) Equation 4:

Assuming that the coordinate point or directional vector p₁ is converted to a coordinate point or directional vector p₂ by rotating the center of origin represented by the quaternion q, the directional vector p₂ can be calculated by Equation 5.

p₂=qp₁q* Equation 5:

The normalized quaternion R(n₁, n₂) which rotates the unit vector n₁ about an axis perpendicular to the plane including the unit vector n₂ so that the unit vector n₁ is superimposed on the unit vector n₂ becomes Equation 6 below.

R(n₁,n₂)=[1−n₂n₁] Equation 6:

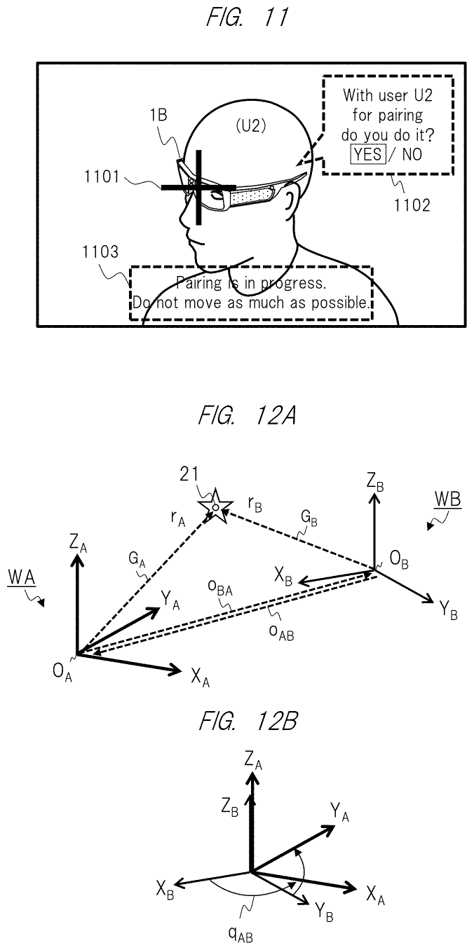

FIGS. 12A to 12B show an explanatory diagram of the coordinate system conversion. FIG. 12A shows, as same with FIG. 8, the representation of the same position 21 in the real space and the representation of the difference of the coordinate origin (O_{A}, O_{B}) between the first terminal coordinate system WA and the second terminal coordinate system WB. As a representation of position 21, a position vector G_{A}, a position coordinate value r_{A}, a position vector G_{B}, and a position coordinate value r_{B} are included. As a representation of the origin differences, inter-origin vectors o_{BA}, o_{AB} are included. The inter-origin vector o_{BA} is a representation of the origin O_{B} of the second terminal coordinate system WB in the first terminal coordinate system WA. The inter-origin vector o_{AB} is a representation of the origin O_{A} of the first terminal coordinate system WA in the second terminal coordinate system WB.

Based on the above-mentioned quantities (FIG. 8), the representation (N_{A}, N_{B}, P_{BA}, P_{AB}) in each terminal coordinate system (WA, WB) for two different specific directions in real space (corresponding specific direction vector and inter-terminal vector) is obtained. Then, the rotation operation between the coordinate systems for matching the representations can be obtained by a calculation using the above-mentioned normalized quaternion. Therefore, by combining these information and the information of each coordinate origin, it is possible to convert the position coordinates between the terminal coordinate systems.

The relation of the terminal coordinate systems (WA, WB) can be calculated as follows. Hereinafter, the calculation for obtaining the rotation and the coordinate origin difference in the case where the representation of the coordinate value and the vector value in the second terminal coordinate system WB is converted into the representation in the first terminal coordinate system WA will be described.

FIG. 12B shows an operation of rotation in which the direction is aligned between the first terminal coordinate system WA and the second terminal coordinate system WB, and shows in simplified manner, for example, an image of a rotation q_{AB} in which the direction of each axis (X_{B}, Y_{B}, Z_{B}) of the second terminal coordinate system WB is aligned with the direction of each axis (X_{A}, Y_{A}, Z_{A}) of the first terminal coordinate system WA.

First, the rotation for matching the direction of the first terminal coordinate system WA and the direction of the second terminal coordinate system WB is obtained. Based on the inter-terminal vector P_{BA}, P_{AB} explained above (FIG. 8), the unit direction vector m_{A}, m_{B} between the terminals 1 is defined as follows. The unit direction vector m_{A}, m_{B} is a representation in the first terminal coordinate system WA and a representation in the second terminal coordinate system WB of the unit vector in the direction from the first terminal 1A to the second terminal 1B in the real space, which is the second specific direction.

m_{A}=[P_{BA}]

m_{B}=[−P_{AB}]

First, consider a rotation q_{T1} in which the unit vector n_{A} in the first specific direction is superimposed on the unit vector n_{B} in the rotation in the representation of the first terminal coordinate system WA. Specifically, q_{T1} of rotations is as follows.

q_{T1}=R(n_{A},n_{B})

Next, the direction in which the unit vector n_{A}, m_{A} in a specific direction is rotated by this rotation q_{T1} is assumed as n_{A1}, m_{A1}.

n_{A}=−q_{T1}n_{A}q_{T1}*=n_{B}

m_{A1}=q_{T1}m_{A}q_{T1}*

Since it is an angle between the same directions in the real space, the angle between the direction n_{A1} and the direction m_{A1} is equal to the angle between the unit vector n_{B} and the unit direction vector m_{B}. Also, since it is assumed in advance that the two specific directions are different directions, the angle between the unit vector n_{B} and the unit direction vector m_{B} is not 0. Therefore, a rotation q_{T2} can be constructed in which the direction n_{A1} or unit vector n_{B} is used as an axis and the direction m_{A1} is superimposed on the unit direction vector m_{B}. Specifically, the rotational q_{T2} is given by a following equation:

q_{T2}=R([P_{T}(n_{B})m_{A1}],[P_{T}(n_{B})m_{B}])

The orientation is invariant by this rotation q_{T2} because it is in the same direction as the rotation axis n_{B} of the rotation q_{T2}. The orientation m_{A1} is also rotated to the unit orientation vector m_{B} by this rotation q_{T2}.

n_{B}=q_{T2}n_{A1}q_{T2}*

m_{B}=q_{T2}m_{A1}q_{T2}*

A rotation q_{BA} is newly defined below.

q_{BA}=−q_{T2}q_{T1}

With this rotation q_{BA}, the unit vector n_{A} and the unit direction vector m_{A} are rotated to the unit vector n_{B} and the unit direction vector m_{B}.

n_{B}=q_{BA}n_{A}q_{BA}*

m_{B}=q_{BA}m_{A}q_{BA}

Since the unit vector n_{A} and the unit direction vector m_{A} are selected as two different directions, this rotation q_{BA} is a rotation that converts the direction representation in the first terminal coordinate system WA to the direction representation in the second terminal coordinate system WB. Conversely, when the rotation that converts the direction representation in the second terminal coordinate system WB to the direction representation in the first terminal coordinate system WA is assumed as a rotation q_{A}, the rotation q_{A} is similarly as follows.

q_{AB}=q_{BA}*

Next, the conversion equation of the coordinate-value d_{A}, d_{B}(FIG. 8) is obtained. The coordinate value d_{A}, d_{B} here is a quaternion representation of the coordinate value defined by Equation 3. First, the coordinate value of the origin of the other coordinate system is obtained as viewed from the one coordinate system. As shown in FIG. 12A, the representation of the coordinate value of the origin O_{B} of the second terminal coordinate system WB in the first terminal coordinate system WA is O_{BA}, and the representation of the coordinate value of the origin O_{A} of the world coordinate system WA in the world coordinate system WB is o_{AB}. Since the coordinate value d_{A}, d_{B} of the position of the terminal 1 in each coordinate system is known, the origin coordinate value representation (o_{BA}, O_{AB}) is obtained as shown in Equation A below.

o_{BA}=d_{A}+P_{BA}−q_{AB}d_{B}q_{AB}*

o_{AB}=d_{B}+P_{AB}−q_{BA}d_{A}q_{BA}* Equation A:

As can be easily understood, there is the following relationship.

o_{AB}=−q_{BA}o_{BA}q_{BA}*

Finally, the conversion equation between the coordinate value r_{A} in the first terminal coordinate system WA for any point (position 21) in the real space and the coordinate value r_{B} in the second terminal coordinate system WB is given as follows.

r_{B}=q_{BA}(r_{A}−o_{BA})q_{BA}*=q_{BA}r_{A}q_{BA}*+o_{AB}

r_{A}=q_{AB}(r_{B}−o_{AB})q_{AB}*=q_{AB}r_{B}q_{AB}*+o_{BA}

As described above, when it is desired to convert the specific position 21 (coordinate value r_{A}) viewed in the first terminal coordinate system WA to the position 21 (coordinate value r_{B}) when viewed in the second terminal coordinate system WB, for example, it can be calculated using the rotation q_{BA}, the coordinate value r_{A}, and the origin representation o_{AB}. The inverse conversion can be calculated as well. Conversion parameter 7 (71, 72) of FIG. 8 and FIG. 9 described above can be constituted by the parameters appearing in the above description. Note that since the conversion can be easily performed with each other as described above, in the configuration and holding of the conversion parameter 7, q_{BA} may be retained instead of the rotation q_{AB}, and o_{AB} may be retained instead of the origin representation o_{BA}, and vice versa.

### [Effects, Etc. (1)]

As described above, according to the space recognition system and method of the first embodiment, the terminal 1 can measure the space 2 to create the space data 6, and can acquire and use the space data 6 from each other among the plurality of terminals 1 of the plurality of users, and can share the recognition of the space 2. According to this system and method, the functions and operations as described above can be efficiently realized, the convenience of the user can be enhanced, and the work load can be reduced. According to this system and method, by utilizing the space data 6, functions and services of various applications can be realized for the user.

The following is also possible as a modification of the first embodiment. In a modified example, the terminal 1 of each user may transmit and register the space data 6 described in the terminal coordinate system created by the own device to an external device such as a PC or a server. Terminal 1 may transmit and register the generated conversion parameter 7 to a device such as an external PC or server.

### [First Modification]

In the first modification of the first embodiment, each terminal 1 measures the space 2 before performing the coordinate system pairing, and creates the space data 6 described in the terminal coordinate system of its own device. Thereafter, the terminal 1 performs coordinate system pairing with the other terminal 1. The terminal 1 uses the conversion parameter 7 to convert the space data 6 into the space data 6 described in a common terminal coordinate system, that is, a common coordinate system.

### [Second Modification]

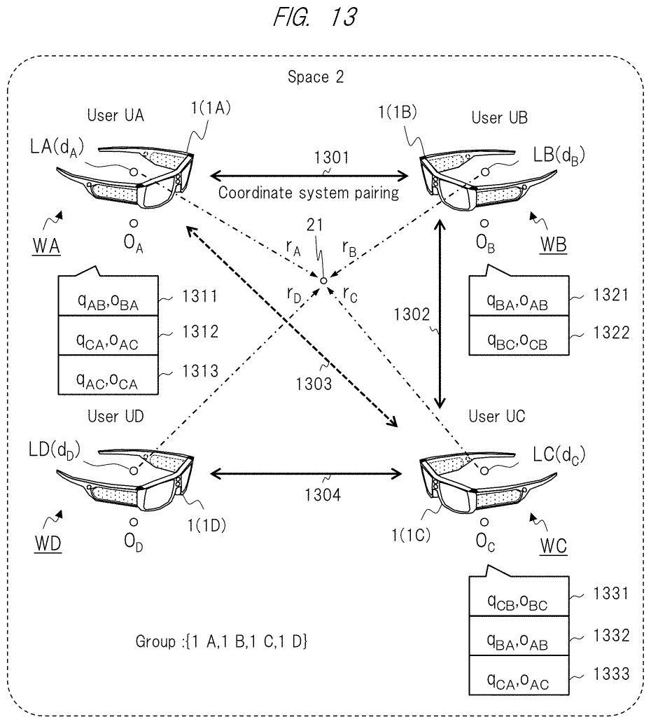

FIG. 13 is a second modification of the first embodiment, showing an explanatory view of a coordinate system pairing or the like in the case of sharing the space recognition sharing the measurement of the space 2 at three or more terminals 1. In this embodiment, four terminals 1A, 1B, 1C, and 1D are provided as four terminals 1 for four users (UA, UB, UC, UD). The terminal coordinate system of each terminal 1 is set as the terminal coordinate systems WA, WB, WC, WD, and each origin is set as the origin O_{A}, O_{B}, O_{C}, O_{D}. These terminals 1 serve as one group for measurement and recognition sharing of the same space 2. On the basis of the coordinate system pairing between the two terminals 1 described in the first embodiment, even in the case of a group of three or more terminals 1, space recognition sharing can be realized by performing the coordinate system pairing between the terminals 1.

For example, consider the terminal 1C of the user UC as its own device. First, as in the first embodiment, it is assumed that a coordinate system pairing 1301 is established between the terminal 1A and the terminal 1B, for example. Next, it is assumed that a coordinate system pairing 1302 is performed between the terminal 1B and the terminal 1C. As a result, a coordinate system pairing 1303 between the terminal 1C and the terminal 1A can be realized indirectly. This will be explained below.

First, by the coordinate system pairing 1301, the terminal 1B, as information 1321 of the conversion parameters, obtains a rotation q_{BA} and the origin representation o_{AB} for the conversion between the terminal coordinate system WA and the terminal coordinate system WB. The rotation q_{BA} is a rotation in which the representation in the terminal coordinate system WA is made to the representation in the terminal coordinate system WB. The origin representation o_{AB} is a coordinate value in the terminal coordinate system WB for the origin O_{A} of the terminal coordinate system WA. Conversely, the terminal 1A obtains the rotation q_{AB} and the origin representation o_{BA} as the information 1311 of the conversion parameter.

Then, by the coordinate system pairing 1302, the terminal 1C, as information 1331 of the conversion parameter, obtains a rotation q_{CB} and the origin representation o_{BC}. The rotation q_{CB} is a rotation in which the representation in the terminal coordinate system WB is made to the representation in the terminal coordinate system WC. The origin representation o_{BC} is a coordinate value in the terminal coordinate system WC for the origin O_{B} of the terminal coordinate system WB. Conversely, the terminal 1B obtains the rotation q_{BC} and the origin representation o_{CB} as information 1322 of the conversion parameter.

Here, the terminal 1C receives information 1321 (rotation q_{BA} and origin representation o_{A}) of the conversion parameter from the terminal 1B and holds it as the information 1332. Thus, the terminal 1C can calculate, the rotation q_{CA} and the origin representation o_{AC} of the indirect coordinate system pairing 1303 with the terminal 1A, by using information 1331 (q_{CB}, o_{BC}) and information 1332 (q_{BA}, O_{AB}) of the conversion parameter. The rotation q_{CA} is a rotation in which the representation in the terminal coordinate system WA is made to the representation in the terminal coordinate system WC. The origin representation o_{AC} is a coordinate value in the terminal coordinate system WC for the origin O_{A} of the terminal coordinate system WA.

q_{CA}=q_{CB}q_{BA}

o_{AC}=o_{BC}+q_{CB}o_{AB}q_{CB}*

The terminal 1C holds the obtained data 1333 (q_{CA}, o_{AC}). The terminal 1C can use the information 1333 to convert the representation (r_{A}) of the position 21 in the terminal coordinate system WA into the representation (r_{C}) in the terminal coordinate system WC, as shown in the following equation.

r_{C}=q_{CA}(r_{A}−o_{CA})q_{CA}*=q_{CA}r_{A}q_{CA}*+o_{AC}

The terminal 1C transmits the information 1333 (q_{CA}, o_{AC}) of the conversion parameter to the terminal 1A. The terminal 1A holds it as information 1312 (q_{CA}, o_{AC}). As a result, the terminal coordinate system WA and the terminal coordinate system WC can be converted even in the terminal 1A because of the following relationships in general. That is, the terminal 1A holds information 1313 (q_{AC}, o_{CA}) of the conversion parameter related to the inverse conversion. In addition, since the following relation exists, one of q_{IJ} or q_{JI} may be held and one of o_{JI} or o_{IJ} may be held in each terminal 1.

q_{IJ}=q_{JI}*

o_{JI}=−q_{IJ}o_{IJ}q_{IJ}*

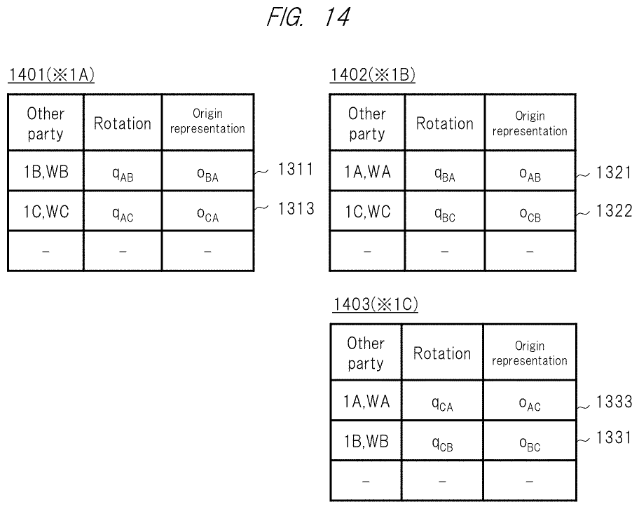

FIG. 14 shows a table 1401 of conversion parameters 7 held by the terminal 1A, a table 1402 of conversion parameters 7 held by the terminal 1B, and a table 1403 of conversion parameters 7 held by the terminal 1C in the coordinate system pairing of the groups of FIG. 13. Each terminal 1 in the group holds the conversion parameter information with each other terminal 1 in the group in a table. Each table has a “partner or other side” item, and stores identification information of the partner or other side terminal 1 and the terminal coordinate system of the coordinate system pairing (here, including the direct coordinate system pairing and the indirect coordinate system pairing). For example, the terminal 1C exchanges information with each terminal 1 (1A, 1B) as a partner, and holds the conversion parameter information between each pair. Specifically, for example, the table 1403 includes information 1333 (q_{CA}, o_{AC}) of the conversion parameter with the terminal 1A and information 1331 (q_{CB}, O_{BC}) of the conversion parameter with the terminal 1B.

As described above, in the second modification, the coordinate system pairing is sequentially performed with any two terminals 1 as a pair, thereby enabling space recognition and sharing within the group. Even if a terminal 1C does not perform a direct coordinate system pairing process with a terminal 1A, an indirect coordinate system pairing 1303 can be performed by performing a coordinate system pairing between the terminal 1A and another terminal 1B for which the coordinate system pairing has been completed. Similarly, even if there is a terminal 1D newly participating in the group, the terminal 1D may perform the same procedure for one terminal 1 in the group, for example, a coordinate system pairing 1304 with the terminal 1C, and a process of the coordinate system pairing with the terminals 1 is not necessary. In the first embodiment and the second modification, since the conversion parameter 7 is held in each terminal 1, the processing can be performed at high speed when the virtual image 22 is displayed at the shared position 21 or the like.

### [Third Modification]

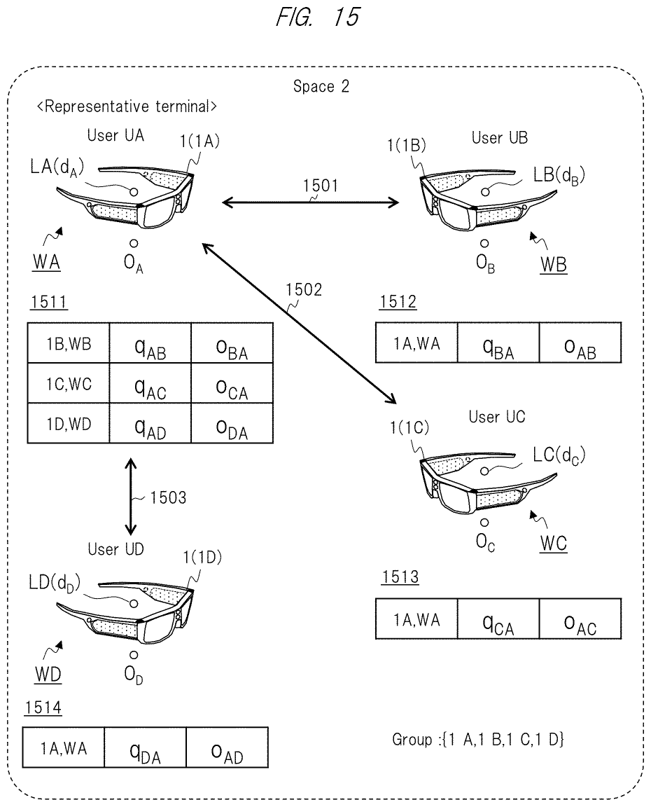

FIG. 15 shows a configuration example relating to the coordinate system pairing and the conversion parameter 7 in the third modification of the first embodiment. In the third modification, one representative terminal 1 (referred to as a “representative terminal”) is provided in a group consisting of a plurality of terminals 1 for sharing space recognition. The representative terminal holds conversion parameters 7 for each terminal 1 of the group. Each terminal 1 other than the representative terminal holds a conversion parameter 7 between the representative terminal and the representative terminal. For example, assume that there is a group similar to that of FIG. 13. For example, the terminal 1A is a typical terminal. The terminal 1A, which is a typical terminal, sequentially performs coordinate system pairing (1501, 1502, 1503) with other terminals 1 (1B, 1C, 1D). In this group, the terminal coordinate system WA of the representative terminal is used as a reference. In the terminal coordinate system WA, a shared position 21 or the like is designated and transmitted between the terminals 1.

A table 1511 of the conversion parameter 7 held by the terminal 1A has conversion parameter information with respect to the respective terminals 1 (1B,1C,1D), similar to the table 1401 of FIG. 14. A table 1512 held by the terminal 1B has a conversion parameter information (q_{BA}, o_{AB}) with the representative terminal. A table 1513 held by the terminal 1C has a conversion parameter information (q_{CA}, o_{AC}) with the representative terminal. A table 1514 held by the terminal 1D has a conversion parameter information (q_{DA}, o_{AD}) with the representative terminal.

For example, when the terminal 1B designates the position 21 (FIG. 13) in the space 2, the terminal 1B converts the representation (r_{B}) of the position 21 in the terminal coordinate system WB into the representation (r_{A}) in the representative terminal using the table 1512 and transmits the representation to the representative terminal. The representative terminal uses the table 1511 to convert the representation (r_{A}) into the representation (r_{C}, r_{D}) in each terminal coordinate system (WC, WD) of each other terminal 1 (1C, 1D) of the group. The representative terminal transmits the position information (r_{C}, r_{D}) to each of the other terminals 1 (1C, 1D).

As another modification, it is possible to make a configuration is possible in which only the representative terminal holds the conversion parameter 7 and performs each conversion. This modification corresponds to a configuration in which the terminals 1B, 1C, 1D do not hold the tables 1512, 1513, and 1514 of the conversion parameter 7 in FIG. 15, for example. For example, the terminal 1B transmits the representation (r_{B}) of the position 21 in the terminal coordinate system WB to the representative terminal. The representative terminal converts the representation (r_{B}) into the representation (r_{A}, r_{C}, r_{D}) in each terminal coordinate system (WA, WC, WD) using the table 1511, and transmits the representation to each terminal 1.

As another modification, the terminal coordinate system of the representative terminal may be fixed as the common coordinate system in the group, and the position may be transmitted between the terminals 1. The representative terminal does not hold the conversion parameter 7. Each terminal 1 other than the representative terminal holds a conversion parameter 7 for conversion with the terminal coordinate system of the representative terminal. This modification corresponds to, for example, a configuration in which the terminal 1A, which is a representative terminal, does not hold the table 1511 in FIG. 15. For example, the terminal 1B converts the representation (r_{B}) of the position 21 in the terminal coordinate system WB into the representation (r_{A}) in the representative terminal using the table 1512, and transmits the representation to the representative terminal. The representative terminal transmits the representation (r_{A}) to the other terminals 1 (1C,1D) of the group. Each terminal 1 (1C,1D) converts its representation (r_{A}) into a representation (r_{C}, r_{D}) in the own terminal coordinate system using its own tables 1513 and 1514.

In addition, in this modification, the position transmission between the terminals 1 may be performed without using the representative terminal. For example, the terminal 1B converts the representation (r_{B}) of the position 21 in the terminal coordinate system WB into the representation (r_{A}) in the representative terminal using the table 1512, and transmits the representation to the terminal 1C. The terminal 1C uses the table 1513 to convert the representation (r_{A}) to the representation (r_{C}) in the own device.

As described above, according to each modification, the quantity of data of the conversion parameter 7 held in the entire system can be reduced.

### Second Embodiment

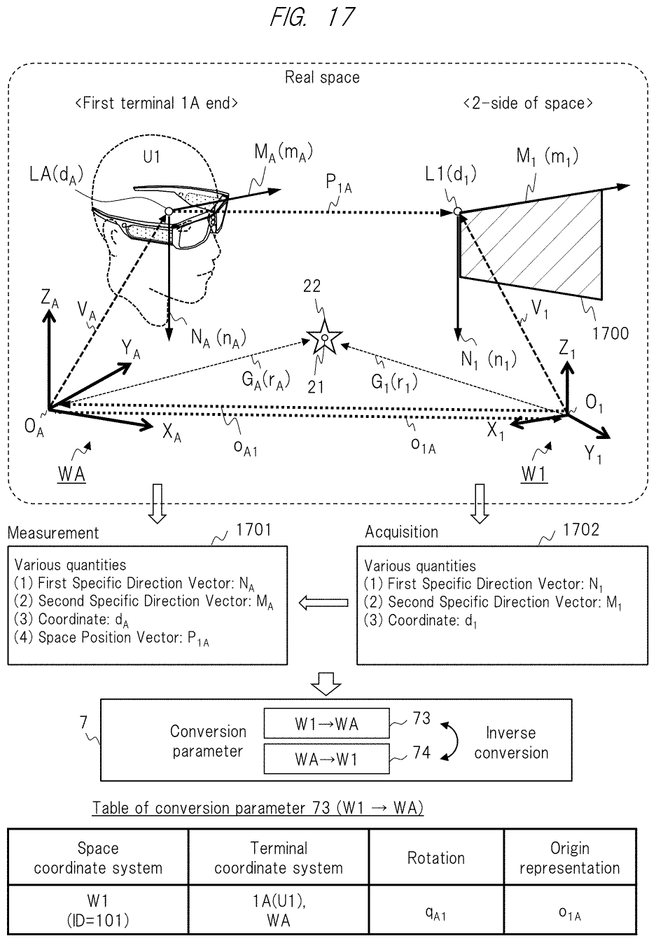

A space recognition system and the like according to the second embodiment of the present invention will be described with reference to FIGS. 16 to 17 and the like. Hereinafter, components in the second embodiment and the like different from those in the first embodiment will be described. In the second embodiment shown in FIG. 16 and the like, a space coordinate system, which is a world coordinate system describing the space 2, is used separately from each terminal coordinate system of the plurality of terminals 1 in the first embodiment. In the second embodiment, the pairing of the coordinate system between the terminal coordinate system and the space coordinate system, in other words, the association and conversion between these coordinate systems are handled. In the second embodiment, the space coordinate system corresponds to the common coordinate system of the basic configuration shown in FIG. 31. Each terminal coordinate system of each terminal 1 sharing the measurement of the space 2 is associated via a common space coordinate system. The space data 6 of the space 2 can in particular be described using a common space coordinate system. The terminal 1 creates space data 6 described in a space coordinate system. Between the terminals 1, the recognition of the space 2 can be shared using the space data 6.

In the second embodiment, at the time of coordinate system pairing, the terminal 1 measures the relationship with a predetermined feature (feature point or feature line) in the space 2 as various quantities. The terminal 1, based on the measured value, obtains the relationship between the space coordinate system associated with the feature and the terminal coordinate system of the own device, and calculates the conversion parameter 7 based on the relationship.

Further, in the second embodiment, the terminal 1 may register the created space data 6 in the DB 5 of an external server 4. In this case, the server 4 corresponds to the information processing apparatus 9 having the basic configuration (FIG. 31). In the second embodiment or the like, a concept of registering the space data 6 from the terminal 1 to an external source such as the server 4 is handled. The server 4 holds and manages the space data 6 which is external data as an external source to the terminal 1. The space data 6 registered as a library in the DB 5 of the server 4 can be referred to and acquired from each terminal 1 (which may be a terminal that does not perform space measurement) as appropriate. The terminal 1 acquires the registered space data 6 patient to the space 2 to be used from the server 4, and can quickly and accurately display an image such as AR using the space data 6 without the need to measure the space 2. For example, a terminal 1 measures a space 2 once to create space data 6 and registers it in the server 4. Subsequently, when the space 2 is reused, the terminal 1 does not need to measure the space 2 again, and can use the space data 6 acquired from the server 4. Business operators may use the server 4 to provide management services for the space data 6.

### [Space Recognition System]

FIG. 16 shows a configuration of the space recognizing system according to the second embodiment, and in particular, shows an explanatory diagram of coordinate system pairing between the first terminal coordinate system WA of the first terminal 1A and the space coordinate system W1 of the space 2. In the present embodiment, the terminal 1 for sharing the measurements of the space 2 includes a first terminal 1A and a second terminal 1B. The second terminal coordinate system WB and the like of the second terminal 1B are not illustrated.

In the second embodiment, information of the space coordinate system W1 related to the space 2 is defined in advance. In the space coordinate system W1, information such as the position of the space 2 and predetermined features such as feature points and feature lines is also defined. The space coordinate system W1 may be, for example, a local coordinate system unique to a building, or may be a coordinate system common to the Earth, an area, or the like. The space coordinate system W1 is fixed in the real space and has an origin O₁ and an axis X₁, an axis Y₁, and an axis Z₁ as three axes perpendicular to each other. In the example of FIG. 16, the origin O₁ of the space coordinate system W1 is separated from the space 2 of the room or the like, but the present invention is not limited to this, and the origin O₁ may be in the space 2.

The second embodiment deals with pairing of coordinate systems between the terminal coordinate system (WA, WB) of the respective terminals 1 and the space coordinate system (W1) of the space 2. These terminals 1 (1A, 1B) share the recognition of the space 2 using the space data 6 created by sharing. Each terminal 1 measures the shape or the like of the space 2 in the terminal coordinate system of its own terminal, and creates space data 6, in particular, space shape data, describing the space 2. At this time, each terminal 1 performs coordinate system pairing with the space coordinate system W1 using a predetermined feature in the space 2 as a clue. Feature points, feature lines, and the like, which are predetermined features in the space 2, are defined in advance. This feature may be, for example, a boundary line such as a wall or a ceiling, or may be a predetermined arrangement or the like. Incidentally, the feature point in a predetermined feature of the space 2 is meaningfully different from the feature point of the point group data obtained by the ranging sensor 13 described above.

For example, the first terminal 1A recognizes predetermined features of the space 2, measures various quantities, and grasps the relation between the first terminal coordinate system WA and the space coordinate system W1. The first terminal 1A, from its relation, generates a conversion parameter 7 of the first terminal coordinate system WA and the space coordinate system W1, and sets it to the own device. Each terminal 1 measures an area to be shared in the space 2 in the state of coordinate system pairing. For example, the first terminal 1A measures the area 2A and obtains a measured data 1601 described in the first terminal coordinate system WA. The first terminal 1A constructs a partial space data 1602 from the measured data 1601. The first terminal 1A converts the partial space data 1602 into the partial space data described in the space coordinate system W1 using the conversion parameter 7. For example, the first terminal 1A acquires the partial space data created by the second terminal 1B from the second terminal 1B. Then, the first terminal 1A integrates the partial space data obtained by itself and the partial space data obtained from the partner into one piece, thereby obtaining the space data 6 described in the space coordinate system W1 in units of the space 2. The second terminal 1B side can also obtain the space data 6 in the same manner as the first terminal 1A side.

In FIG. 16, the space recognition system of the second embodiment includes a server 4 connected to a communication network. The server 4 is a server device managed by a business operator or the like, and is provided, for example, on a data center or a cloud computing system. The server 4 registers and holds ID and the space data 6 as a library in the internal or external database (DB) 5. For example, ID=101 is assigned to the space 2 shown in the figure, and space data 6 (D101) identified by ID=101 is registered in the DB 5. For each of the plurality of spaces 2, the space data 6 is similarly registered. The server 4 may manage the closed space data 6 in the unit of a company or the like, or may manage a large number of the space data 6 in the unit of The Earth, an area, or the like. For example, when the space data 6 is managed in units of a company's building, each space data 6 related to each space 2 in the building is registered in the server 4 of the computer system such as the company's LAN.

In the second embodiment, space data 6 relating to each space 2 in the real space is registered as a library, particularly in the DB 5 of the server 4 which is an external source. At first, in the stage prior to the space 2 being measured, a space shape data 61 of the space data 6 of the DB 5 is not registered. The space data 6 of the DB 5 includes the space shape data 61 and the feature data 62. The space shape data 61 is data representing the shape or the like of the space 2 described in the space coordinate system W1, and is a portion created by the terminal 1. The feature data 62 includes data defining quantities of predetermined features, such as feature points and feature lines, in the space 2. The feature data 62 is referred to during the coordinate system pairing by the terminal 1.

The space data 6 of the DB 5 may be described in a unique space coordinate system corresponding to the space 2, or may be described in a shared space coordinate system among a plurality of related spaces 2 (e.g., buildings). The common space coordinate system may be a common coordinate system within the Earth or the area. For example, it may be a coordinate system using latitude, longitude and altitude in GPS or the like.

The configuration of the space data 6 is an example, and the details thereof are not limited. As data different from the space data 6, there may exist a space coordinate system W1 defined in advance, data relating to features and various quantities, and the like. The feature data 62 may be described as a part of the space shape data 61. The feature data 62 may be held in advance in the terminal 1. Various types of data may be maintained in different locations and associated through identification information. The server 4 is not limited to one, and may be a plurality of servers 4, for example, a server 4 associated with each one or more spaces 2.

In particular, in the second embodiment, each terminal 1 can register the space data 6 created by measuring the space 2 in the DB 5 of the server 4. At this time, the space data 6 created by the terminal 1 is registered with respect to the space data 6 (in particular, the space shape data 61) registered in advance in the DB 5. In other words, the space data 6 of the server 4 is appropriately updated according to the registration of the space data 6 from the terminal 1. Each of the terminals 1 can appropriately acquire and use the registered space data 6 from the DB 5 of the server 4. Each terminal 1 does not have to hold the space data 6 inside its own device.

In the second embodiment, the space data 6 of each space 2 may be registered as a library in an external source such as the server 4, but the present invention is not limited to this, and the space data 6 may be held in the terminal 1 as a library. Each terminal 1 that shares the recognition of the space 2 may only create and send and receive the space data 6 between the terminals 1 and share and hold it.

### [Coordinate Conversion]

FIG. 17 shows an explanatory diagram of coordinate system pairing between the terminal coordinate system WA and the space coordinate system W1 in the second embodiment. In the second embodiment, a feature point or a feature line of a predetermined object 1700 such as a wall or a ceiling is used as a predetermined feature in the space 2. The terminal 1 uses the predetermined feature point or feature line at the time of coordinate system pairing with the space coordinate system W1. In the example of FIG. 17, four corner points of a rectangular surface in an object 1700, such as a wall, are used. In the example of FIG. 17, in particular, three feature points and two feature lines corresponding to the left side and the upper side in the plane of the object 1700 are used. The two feature lines correspond to two specific directions. The predetermined feature in the space 2 is defined by the feature data 62 (FIG. 16), it may be arbitrary as long as the terminal 1 can be recognized by a camera, a sensor, or the like. The predetermined feature is not limited to a wall or the like, and may be, for example, a predetermined object set by a user in a room.

In the present exemplary embodiment, unlike the position of the origin O_{A} of the terminal coordinate system WA and the position LA of the first terminal 1, and the position of the origin O₁ of the space coordinate system W1 is different from the position L1 of the feature point in the space 2, but the present invention is not limited to this. Hereinafter, a case where the origin of the terminal coordinate system does not coincide with the position of the terminal 1 and a case where the position of the origin of the space coordinate system does not coincide with the position of the feature point of the space 2 will be described.

The coordinate in the terminal coordinate system WA with respect to the position LA of the terminal 1 is assumed to be d_{A}=(x_{A}, y_{A}, z_{A}). The coordinate value in the space coordinate system W1 with respect to the position L1 of the feature point in the space 2 is assumed to be d₁=(x₁, y₁, z₁). These coordinate values are determined in accordance with the setting of the world coordinate system. The terminal position vector V_{A} is a vector from the origin O_{A} to the position LA. The feature point position vector V1 is a vector from origin O₁ to position L1.

At the time of coordinate system pairing, the terminal 1 acquires information on the space coordinate system W1 from the server 4 (or the reference terminal in the modification). For example, the terminal 1 refers to the feature data 62 of the space data 6 from the server 4. The feature data 62 includes data of various quantities 1702 relating to the feature on the space 2 side, i.e., the corresponding object 1700. Terminal 1 measures the quantities 1701 of its own device side, using a ranging sensor 13 or the like. The terminal 1 obtains the relationship between the terminal coordinate system WA and the space coordinate system W1 based on the quantities 1702 on the space 2 side and the measured quantities 1701 on the own device side. Terminal 1, based on the relationship, calculates the conversion parameter 7 between their coordinate systems, and sets to the own device.

As various quantities in the pairing of the coordinate system, information of the following three elements is included. The quantities include a specific direction vector as first information, a world coordinate value as second information, and a space position vector as third information. In the exemplary embodiment of FIG. 17, a first specific direction vector N_{A}, a second specific direction vector M_{A}, a coordinate value d_{A}, and a space position vector are provided as the quantities 1701 on the own device side. As the quantities on the space 2 side, it has a first specific direction vector N₁, a second specific direction vector M₁, and a coordinate value d₁.

(1) Regarding specific direction vector: The terminal 1 uses a specific direction vector as information about a specific direction in the space 2 in the terminal coordinate system. This specific direction includes a direction which is measured by a sensor of the terminal 1, for example, a direction such as the vertical downward direction, and a direction of the feature line in the space 2, for example, a direction corresponding to the left side or the upper side of the object 1700. The terminal 1 may use unit vectors in two different specific directions from among a plurality of candidates. The representation of these unit vectors in the space coordinate system W1 is taken as n₁, m₁, and the representation in the terminal coordinate system WA is taken as n_{A}, m_{A}. The unit vectors n_{A}, m_{A} in the terminal coordinate system WA are measured by the terminal 1. The unit vectors n₁, m₁ in the space coordinate system W1 are predetermined and can be acquired from the feature data 62 of the server 4.

When the vertical downward direction is used as one specific direction, the vertical downward direction can be measured as the direction of gravitational acceleration using an acceleration sensor as described above. Alternatively, in the world coordinate system (WA, W1) settings, the vertical downward direction may be set as the negative direction of the Z-axis (Z_{A}, Z₁). In any case, since the vertical downward direction does not change in the world coordinate system, it is not necessary to measure each time the coordinate system pairing.

When using the north direction of the geomagnetism, for example, as one specific direction, the north direction of the geomagnetism can be measured using a geomagnetic sensor 143 provided in the terminal 1 (FIG. 7). Since geomagnetism may be affected by structures, it is preferable to measure at every coordinate system pairing. If it is known that the influence of the structure is sufficiently small, the measurement may be omitted and the direction that is recognized as the north direction of the geomagnetism may be used.

When the direction of a predetermined feature line in the space 2 is used as the specific direction, for example, when the directions of the two feature lines of the left side and the upper side of the object 1700 are used as the two specific directions, the measurement can be performed as follows. The terminal 1 measures position coordinate values in the terminal coordinate system WA for two different feature points constituting the feature line for each feature line. The terminal 1 obtains a direction vector (for example, a direction vector N_{A}(n_{A}) corresponding to the left side and a direction vector M_{A}(m_{A}) corresponding to the upper side) from the measured value. This coordinate value can be measured, for example, by the ranging sensor 13 of the terminal 1.

(2) Regarding world coordinate value: The terminal 1 uses information of a coordinate value representing a position in the terminal coordinate system. In the example of FIG. 17, as the world coordinate value, the coordinate value d_{A} in the first terminal coordinate system WA and the coordinate value d₁ in the space coordinate system W1 are used. In the present exemplary embodiment, as a feature of the object 1700, one feature point in the upper left is the position L1 (coordinate value d₁).
(3) Regarding space position vector: The space position vector (space position vector P_{1A}) is a vector from the position LA of the terminal 1 to the position L1 of the feature point of the space 2. The space position vector provides information about the positional relation between the two coordinate systems (WA, W1). The space position vector can be measured, for example, by the ranging sensor 13 of the terminal 1.

In FIG. 17, the position vector G_{A} is a vector at position 21 in the first terminal coordinate system WA, and the position coordinate value r_{A} is a coordinate value at position 21. The position vector G1 is a vector at position 21 in space coordinate system W1, and the position coordinate value r₁ is a coordinate value at position 21. The inter-origin vector o_{1A} is a vector from the origin O_{A} to the origin O₁ and is a representation of the origin O₁ in the first terminal coordinate system WA. The inter-origin vector o_{A1} is a vector from the origin O₁ to the origin O_{A} and is a representation of the origin O_{A} in the space coordinate system W1.

### [Conversion]

Since the relation between the first terminal coordinate system WA and the space coordinate system W1 is known from the quantity data (1701, 1702), the conversion between these world coordinate systems (WA, W1) can be calculated. That is, as the conversion parameter 7, a conversion parameter 73 for converting the space coordinate system W1 to the first terminal coordinate system WA, and as an inverse conversion, a conversion parameter 74 for converting the first terminal coordinate system WA to the space coordinate system W1 can be configured. The conversion parameter 7, as described in the first embodiment, can be defined using the rotation and the coordinate origin difference.

After the coordinate system pairing, any world coordinate system may be used for the recognition of the position in the space 2 by the terminal 1. The position in the space coordinate system W1 may be converted into the position in the first terminal coordinate system WA by the conversion parameter 73. The position in the first terminal coordinate system WA may be converted into the position in the space coordinate system W1 by the conversion parameter 74.

The table of conversion parameters 73 in the example of FIG. 17 has, as items, a space coordinate system, a terminal coordinate system, a rotation, and an origin representation. The “space coordinate system” item stores the identification information of the space coordinate system. The “terminal coordinate system” item stores the identification information of the terminal coordinate system or the identification information of the corresponding terminal 1 or the user. The “rotation” item stores the information (e.g., q_{A1}) of the representation of the rotation between their space coordinate system and the terminal coordinate system. The “origin representation” item stores the representation of the difference between the origin of the space coordinate system and the origin of the terminal coordinate system (e.g., o_{1A}).

Since the calculation method of the conversion parameter 7 in the second embodiment is the same as that in the first embodiment, only the calculation result will be described below. The conversion equation between the coordinate value r_{A} in the terminal coordinate system WA for any point (position 21) in the space 2 and the coordinate value r₁ in the space coordinate system W1 is given as follows.

r₁=q_{1A}(r_{A}−o_{1A})q_{1A}*=q_{1A}r_{A}q_{1A}*+o_{A1}

r_{A}=q_{A1}(r₁−o_{A1})q_{A1}*=−q_{A1}r₁q_{A1}*+o_{1A}

However, the quantities in the above equation are given by the following:

q_{T1}=R(n_{A},n₁)

m_{A1}=q_{T1}m_{A}q_{T1}*

q_{T2}=R([P_{T}(n₁)m_{A1}],[P_{T}(n₁)m₁])

q_{1A}=q_{T2}q_{T1}

q_{A1}=q_{1A}*

o_{1A}=d_{A}+P_{1A}−q_{A1}d₁q_{A1}*

o_{A1}=d₁−q_{1A}(d_{A}+P_{1A})q_{1A}*

As described above, for example, when the position 21 (coordinate value r_{A}) viewed in the first terminal coordinate system WA is to be converted into the position 21 (coordinate value r₁) viewed in the space coordinate system W1, it can be calculated using the rotation q_{1A}, the coordinate value r_{A}, and the origin representation (o_{A1}). The inverse conversion can be calculated as well. The conversion parameter 7 in the second embodiment can be configured by the parameters appearing in the above description. In the configuration and holding of the conversion parameter 7, as in the first embodiment, since it can be easily converted to each other, for example, it may be a q_{1A} instead of the rotation q_{A1}.

### [Effects, Etc. (2)]

As described above, according to the second embodiment, the space data 6 corresponding to the space coordinate system W1 of the space 2 used as the common coordinate system can be created by each terminal 1 and registered in the server 4, and the recognition of the space 2 can be shared among the plurality of terminals 1 of the plurality of users.

The following is also possible as a modification of the second embodiment. In a modified example, the terminal 1 measures the space 2 and creates the space data 6 described by the terminal coordinate system of its own device before performing the coordinate system pairing. Thereafter, the terminal 1 performs coordinate system pairing with the space coordinate system W1, and converts the space data 6 described in the terminal coordinate system into the space data 6 described in the space coordinate system W1 using the conversion parameter 7.

As a modification of the first and second embodiments, the following is also possible. The information provided between the terminals 1 or between the terminal 1 and the server 4 may include data such as a virtual image (AR object) related to a function such as the AR or the arrangement position information of the virtual image. For example, in FIG. 16, such data may be exchanged between the server 4 and each terminal 1 through space data 6. Data such as the AR object may be provided from the terminal 1 to the server 4 and registered in association with the space data 6. Data such as an AR object may be provided from the server 4 to the terminal 1 along with space data 6. In the DB 5 library, in the space data 6, the data and the arrangement position information of the AR object to be arranged and displayed in the space 2 are registered in association with the space shape data 61 and the like. Thus, various services can be provided to the user through the terminal 1. For example, a store (corresponding space 2) that sells commodities can provide the terminal 1 with the AR objects such as commodity advertisements together with the space data 6.

### [Fourth Modification]

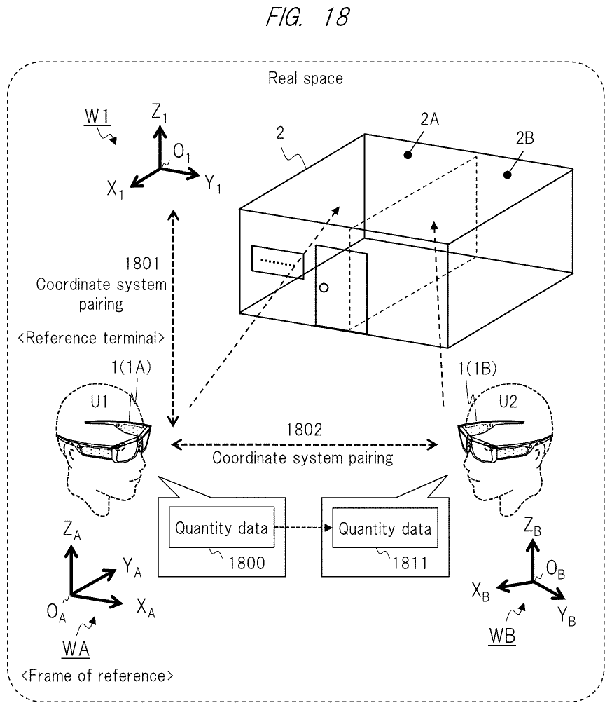

FIG. 18 shows a configuration of a modification (fourth modification) of the second embodiment. Of the plurality of terminals 1 that perform sharing and assignation, a specific terminal 1 may be used as a reference (referred to as a “reference terminal”) and a terminal coordinate system of the reference terminal may be designated as a reference (referred to as a “reference coordinate system”). In this case, the reference terminal measures and holds the features of the space 2 (the feature points and the directions of the feature lines) as a quantity data 1800 in the reference coordinate system. The reference terminal performs coordinate system pairing 1801 with the space coordinate system W1 of the space 2. Each terminal 1 other than the reference terminal, for example, the second terminal 1B receives the quantity data 1800 from the reference terminal, and performs coordinate system pairing 1802 with the reference terminal. The coordinate system pairing 1802 is the same as the coordinate system pairing described in the first embodiment. As a result, each terminal 1 that has performed coordinate system pairing with the reference coordinate system realizes indirect coordinate system pairing with the space coordinate system W1 via the reference coordinate system.

### Third Embodiment

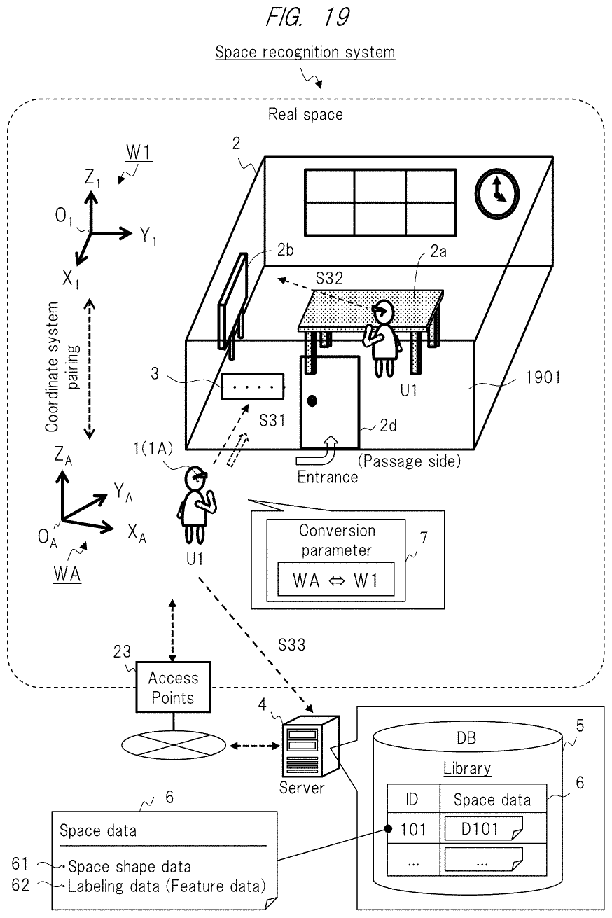

A space recognition system and the like according to a third embodiment of the present invention will be described using FIGS. 19 to 24 and the like. The third embodiment shown in FIG. 19 and the like is a development form of the second embodiment, and the point that the pairing of the coordinate system between the terminal coordinate system and the space coordinate system is handled is the same, and a feature of the mark 3 is used for measurement of the space 2 and the like as a different configuration point. In the third embodiment, the terminal 1 measures the space 2 using the space coordinate system W1 related to the mark 3, and creates the space data 6. The terminal 1 may register and store the created space data 6 in the DB 5 of the server 4.

### [Space Recognition System and Method]

FIG. 19 shows a configuration of a space recognition system and method according to the third embodiment. The space recognition system of the third embodiment has a mark 3. A mark 3 corresponding to the space 2 is installed in the space 2. In the example of FIG. 19, in the space 2 which is a room, for example, the mark 3 is installed on the outer surface of the wall 1901 of the entrance.

Mark 3 (in other words, marker, sign, etc.) has a special function for terminal 1 in addition to its function as a general mark that allows the user to identify space 2. The mark 3 gives a world coordinate system serving as a reference for the space 2 as the space coordinate system W1 (which may be referred to as a mark coordinate system). The mark 3 is a specific object in which a predetermined feature is defined and which can be used for measurement of various quantities and the like at the time of coordinate system pairing by the terminal 1. The mark 3 has a function for enabling the terminal 1 to identify the space 2 (corresponding ID) and acquire the space data 6. The mark 3 is described a position, a shape, and the like in the same space coordinate system W1 as the space 2. The feature in the space 2 in the second embodiment is a feature point or a feature line as a feature of the mark 3 in the third embodiment. The feature of the mark 3 is defined in advance as various quantities. For example, in the space data 6 of the DB 5 of the server 4, the mark data 62 is registered. The mark data 62 includes various quantity data of the mark 3, and corresponds to the feature data 62 in the second embodiment.

Terminal 1, for example, the first terminal 1A measures the features of the mark 3 as various quantity data of the own device side, grasps the relationship between the first terminal coordinate system WA and the space coordinate system W1, based on the relationship, the first terminal coordinate system WA and the space coordinate system W1 generating a conversion parameter 7, and sets the own device.

### [Mark]

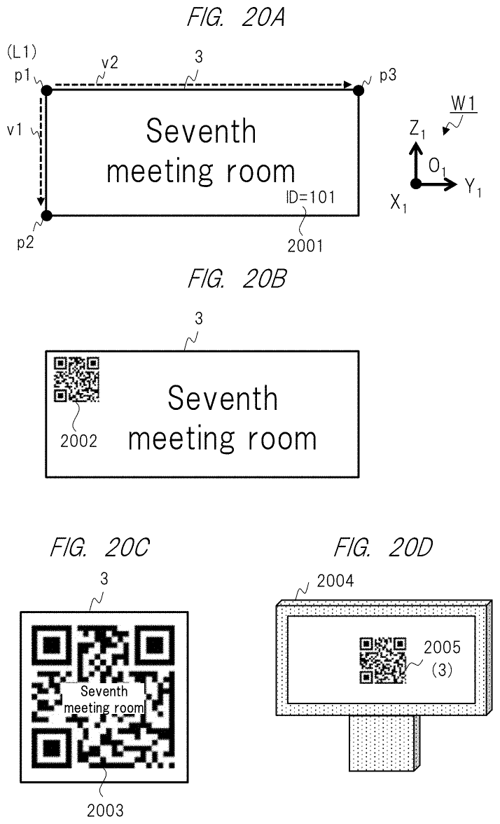

FIGS. 20A to 20D show configuration examples of the mark 3. FIG. 20A is a first example, FIG. 20B is a second example, FIG. 20C is a third example, and FIG. 20D is a fourth example. In FIG. 20A, the mark 3 is composed of a horizontally long rectangular plate or the like, and on the surface of the plate or the like (sometimes referred to as a mark surface), a character string of “seventh conference room” indicating the name of the room which is the space 2 is described. In this embodiment, the mark plane is located on Y₁-Z₁ plane of the space coordinate system W1. In this example, the space 2 and ID 2001 of the mark 3 are directly described as character strings in one place of the mark surface. The terminal 1 can recognize ID 2001 by the cameras 12.

In this example, a feature point or a feature line in the space coordinate system W1 is defined in advance on the mark surface of the mark 3. In the mark plane, one feature point (point p1) representing a representative position L1 of the mark 3 is defined. Two other feature points (points p2, p3) are defined on the mark plane. The three feature points (points p1-p3) define two feature lines (lines v1, v2 corresponding to the vector). The point p1 is an upper left corner point of the mark surface, the point p2 is a lower left corner point, and the point p3 is an upper right corner point. The line v1 is the left side of the mark surface, and the line v2 is the upper side. These feature points and feature lines constitute the two specific directions described above. The quantity data relating to the space coordinate system W1 of the mark 3 includes, for example, the information of one feature point (point p1) and the information of two specific directions (line v1, v2). It should be noted that although the feature points such as the point p1 and the feature lines such as the line v1 are illustrated for the purpose of explanation, they are not actually described. Alternatively, a feature point or a feature line may be described on the mark surface as a specific image so that it can be recognized by the user and the terminal 1.

The terminal 1 measures the relationship with the mark 3 as various quantities during the coordinate system pairing. At that time, the terminal 1 measures these three feature points (points p1 to p3) using the ranging sensor 13 and the camera 12 based on the mark data 62. In other words, the terminal 1 measures two feature lines (line v1, v2). When the positions of the three feature points in the terminal coordinate system WA can be grasped, the two feature lines corresponding to the two specific directions can be grasped.

Incidentally, the origin O₁ of the space coordinate system W1 may be outside the space 2, may be in the space 2, or may be set in particular to the mark surface of the mark 3. For example, the origin O₁ may be set in accordance with the feature point (point p1) of the mark 3.

In FIG. 20B, the mark 3 is described a predetermined code (code image) 2002 at one place of the same mark surface as in (A), for example, in the vicinity of the upper left point p1. The code 2002 is a code in which there is described predetermined information. The code 2002 may be a two-dimensional code such as a QR code (QR: Quick Response, registered trademark). The terminal 1 extracts a code 2002 from the image of the camera 12, and obtains predetermined information by decoding.

In FIG. 20C, the mark 3 is configured as an image or a medium of a code 2003. For example, the mark 3 may be a pasting medium on which a QR code is written. In this example, a character string of the name of the room is described on a surface of the code 2003. The terminal 1 may measure, for example, three corner points of the code 2003 as feature points in the same manner. Alternatively, the terminal 1 may measure three clipped symbols for recognition of the QR code as feature points.

In FIG. 20D, the mark 3 is composed of a display image of a display device 2004 (e.g., a wall-mounted display). A code 2005 is displayed on the screen of the display device 2004, and functions as the mark 3. In this case, a change of the mark 3 is easily possible.

The predetermined information described in the mark 3 may be information including an ID 2001 for identifying the space 2 and the mark 3, or may be information including an address and a URL for accessing the space data 6 of the server 4 as an external source, or may be configured as follows.

The predetermined information may be information including various quantity data relating to the space coordinate system W1 of the mark 3, i.e., the mark data 62 in FIG. 19, and space data transmission destination information. The space data transmission destination information is external source information, and is identification information of the transmission destination about the space data 6 (in particular, the space shape data) measured and created by the terminal 1, and is, for example, an address or a URL of the server 4.

The predetermined information may be information including a predetermined ID and space data transmission destination information. The terminal 1 can use this information to access the server 4 and obtain space data 6 (in particular, the mark data 62) associated with the mark 3. The terminal 1 can acquire various quantity data from the mark data 62.

### [Space Data Registration]

In FIG. 19, as the space recognition method according to the third embodiment, a processing flow example in which a plurality of terminals 1 measure the space 2 by sharing, create the space data 6 in units of the space 2, and register it in the server 4 is as follows. First, in step S31, the terminal 1, for example, the first terminal 1A, recognizes the mark 3 in the real space by the cameras 12 or the like, and measures various quantities with respect to the features of the mark 3. The terminal 1 performs coordinate system pairing between the terminal coordinate system WA of the own terminal 1 and the space coordinate system W1 of the mark 3 by using various quantity data as measured values. As a result, the terminal 1 sets the conversion parameters 7 between the terminal coordinate system WA and the space coordinate system W1 as the common coordinate system.

Next, in step S32, the terminal 1 measures the space 2 (above mentioned sharing area) in the terminal coordinate system WA, and creates the space data 6 described in the space coordinate system W1 using the conversion parameters 7. The terminal 1 appropriately converts the position or the like in the terminal coordinate system WA in the measurement data or the partial space data into the position or the like in the space coordinate system W1. The details of the processing in step S32 are the same as those described above.

In step S33, the terminal 1 transmits the space data 6 described in the created space coordinate system W1 to the server 4 based on the predetermined information of the mark 3. The terminal 1 may attach the identification information of the own device or the user, the position information (measurement starting point), the measurement date and time information (time stamp), and other related information to the space data 6 to be transmitted. When there is the measurement date and time information, the server 4 can grasp changes in the space data 6 on the time axis (states such as the shape of the space 2 or the like), as a data management.

The server 4 registers and stores the space data 6 (in particular, the space shape data) received from the terminal 1 in the library of the DB 5. The server 4 registers the space data 6 (in particular, the space shape data 61) in association with the information such as the ID of the space 2. When the corresponding space data 6 (in particular, the space shape data 61) has already been registered in the DB 5, the server 4 updates the content of the space data 6. The server 4 manages the measurement date and time, the registration date and time, the update date and time, and the like of the space data 6.

Alternatively, the following may be used. In steps S32 to S33, the terminal 1 creates the space data 6 described by the terminal coordinate system WA of the own device based on the measurement data. The terminal 1 transmits the space data 6 described in the terminal coordinate system WA and the conversion parameter 7 (a conversion parameter that can be converted from the terminal coordinate system WA to the space coordinate system W1) as a set to the server 4. The server 4 registers those data in the DB 5.

### [Control Flow]

FIG. 21 shows an example of the processing flow of the exchange related to the registration of the space data 6 between the terminal 1 and the server 4 according to the third embodiment. In this example, based on the mark 3, a communication connection between the terminal 1 and the server 4 is established, and a coordinate system pairing is established. In this state, the terminal 1 measures the space 2 to create the space data 6, transmits it to the server 4, and registers it. The same flow is performed relating to a plurality of terminals 1 of a plurality of users, which share the measurement of the space 2.

In step S301, the terminal 1 recognizes the mark 3, reads predetermined information (e.g., ID and space data transmission destination information), and establishes a communication connection with the server 4 based on the predetermined information. In step S301b, the server 4 establishes a communication connection with the terminal 1. At this time, the server 4 may authenticate the user or the terminal 1, confirm the authority related to the space 2, and permit the terminal 1 whose authority is confirmed. As the authority, for example, an authority for measurement, an authority for registration and update of the space data 6, an authority for acquisition and use of the space data 6, and the like may be provided.

In step S302, the terminal 1 transmits the coordinate system pairing request to the server 4, and in step S302b, the server 4 transmits the coordinate system pairing response to the terminal 1.

In step S303, the terminal 1 sends a request for various quantities of data regarding the mark 3 to the server 4. In a step S303b, the server 4 transmits the corresponding mark data 62 to the terminal 1 as a response to various quantity data relating to the mark 3. The terminal 1 acquires quantity data relating to the mark 3.

In step S304, the terminal 1, based on the quantity data obtained above, a predetermined feature of the mark 3 (point p1 and lines v1, v2 in FIG. 20) is measured by the terminal coordinate system WA, obtained as various quantity data of the own device. The measurement at this time is possible by means of the ranging sensor 13.

In step S305, the terminal 1 calculates the conversion parameter 7 between the terminal coordinate system WA and the space coordinate system W1 using the various quantity data described by the space coordinate system W1 on the mark side obtained by the step S303 and the various quantity data described by the terminal coordinate system WA on the own device side obtained by the step S304, and sets it to the own device.

In step S306, the terminal 1 measures the space 2, obtains measured data, and creates space data 6 (in particular, the space geometry data) described in its terminal coordinate system WA. In detail, the space data 6 is partial space data based on sharing.

In step S307, the terminal 1 converts the space data 6 created in step S306 into the space data 6 described in the space coordinate system W1 using the conversion parameter 7.

In step S308, the terminal 1 transmits the space data 6 obtained in step S307 to the server 4. In step S308b, the server 4 registers or updates the space data 6 received from the terminal 1 in the corresponding space data 6 (in particular, the space shape data 61) in the DB 5.

In another method, instead of steps S307, S308, the terminal 1 transmits the space data 6 and the conversion parameter 7 described in the terminal coordinate system WA of the own device as a set to the server 4. The server 4 registers the space data 6 and the conversion parameter 7 in association with each other in the DB 5. In this configuration, the server 4 may perform the coordinate conversion process using conversion parameters 7 of the DB 5.

In steps S309, S309b, the terminal 1 and the server 4 confirm whether or not the coordinate system pairing related to the space measurements is to be finished, and if the pairing is to be finished (Yes), the processing proceeds to step S310, and if the pairing is to be continued (No), the processing returns to step S306, and the processing is repeated in the same manner.

In steps S310, S310b, the terminal 1 and the server 4 disconnect the communication connection related to measuring the space 2. The terminal 1 and the server 4 may explicitly cancel the state of the coordinate system pairing (e.g., deleting the conversion parameter 7), or may be continued thereafter. The terminal 1 may be connected to the server 4 at all times via communication, or may be connected to the server 4 only when it is necessary. Basically, a method (client-server method) that does not hold data such as space data 6 or the like may be used in the terminal 1.

In the above control flow example, the terminal 1 automatically transmits the created space data 6 to the server 4 and registers. As not limited to this, the user may perform an operation for registering space data in the terminal 1 and register the space data 6 in the server 4 according to the operation. The terminal 1 displays a guide image related to the space data registration on the display surface 11. The user performs as operation for the space data registration accordingly.

### [Use of Space Data]

When the space data 6 of the space 2 (in particular, the space shape data 61) has been registered in the server 4 as described above, each terminal 1 can acquire and use the space data 6 by communication, particularly through the mark 3. The procedure at this time is as follows, for example.

The terminal 1 recognizes the corresponding mark 3 for the target space 2, acquires predetermined information (such as an ID or the like), and checks whether the coordinate system has been paired or whether the space data 6 has been registered, and the like. For example, when the space data 6 has already been registered, the terminal 1 acquires the space data 6 (in particular, the space shape data 61) related to the target space 2 from the server 4 using the predetermined information. When the coordinate system pairing has not been completed, the terminal 1 performs the coordinate system pairing with the space 2. When the conversion parameter 7 is already held in the terminal 1, the coordinate system pairing can be omitted.

When the terminal 1 recognizes the mark 3, or the like, it may possible to display an image for the option or guide on the display surface 11 for the user to measure the space 2 (creation of the corresponding space data 6 or acquire and use the registered space data 6, and to determine the subsequent processing according to the user's operation. For example, when the space data 6 is used based on the user's operation, the terminal 1 transmits a space data request to the server 4. The server 4 retrieves the DB 5 in response to the request, and when there is the target space data 6 (in particular, the space shape data 61), and transmits the space data 6 to the terminal 1 as a response.

The terminal 1 can suitably display the virtual image 22 in the space 2 at a position 21 that matches the shape of the object in the space 2 by, for example, an AR function using the acquired space data 6. The space data 6 (in particular, space shape data 61) can be used for various applications in addition to the use of the AR function to display the virtual image 22. For example, it can be used for the purpose of grasping the positions of the user and the own device, or for the purpose of searching for a route to a destination or guidance. For example, the HMD, which is the terminal 1, displays the shape of the space 2 on the display surface 11 using the acquired space data 6. At this time, the HMD may superimpose and display the shape of the space 2 on the real object by a virtual image of a line drawing, for example, in a real object size. Alternatively, the HMD may display the shape of the space 2 in a virtual image, such as a three-dimensional map or a two-dimensional map, with a size smaller than that of the real object. In addition, the HMD may display a virtual image representing the current position of the user and the own device on the map. Further, the HMD may display the position of the user's destination and the route from the current position to the destination position in the map as a virtual image. Alternatively, the HMD may display a virtual image such as an arrow for route guidance in accordance with the actual object.

### [Effects, etc. (3)]

As described above, in the third embodiment, in particular, efficient coordinate system pairing and space data acquisition are possible using the mark 3. In the second and third embodiments, when the terminal coordinate system WA of the terminal 1 is paired with the space coordinate system W1 on the side of the space 2 and the mark 3, the object in the space 2 or the mark 3 is fixed. Therefore, during this coordinate system pairing, it is sufficient to consider stationary of the terminal 1 side, it is possible to measure with high accuracy, the degree of freedom in practical use is increased.

As a modification of the third embodiment, with respect to the coordinate system pairing between the terminal coordinate system of the terminal 1 and the space coordinate system of the mark 3, similarly to a fourth modification (FIG. 18) of the second embodiment, an indirect coordinate system pairing method can also be applied. For example, when performing the coordinate system pairing with the space coordinate system W1 of the mark 3 (FIG. 19), the second terminal 1B may perform the coordinate system pairing with the first terminal 1A which has already been finished, instead. As a result, the second terminal coordinate system WB of the second terminal 1B can realize the indirect coordinate system pairing with the space coordinate system W1 of the mark 3 via the first terminal coordinate system WA.

In the third embodiment, after the coordinate system pairing with the mark 3, the terminal 1 may use a predetermined feature point and feature line obtained by a measuring in the space 2 for a calibration (adjustment) relating to the coordinate system pairing (corresponding conversion parameter 7). In addition, a plurality of marks 3 or features may be provided in one space 2. The terminal 1 can use the respective mark 3 or features for the coordinate system pairing or adjustment.

### [Fifth Modification]

As a modification (referred to as a fifth modification) of the first to third embodiments, the following is also possible. The fifth modification deals with the sharing on the time axis in the case where the space data 6 is generated by measuring a certain space 2. In this case, either one or more users can be used. Even if there is only one terminal at the same time, sharing on a time axis is possible. In this case, each terminal 1 takes charge of each time in a plurality of times formed by a temporal division.

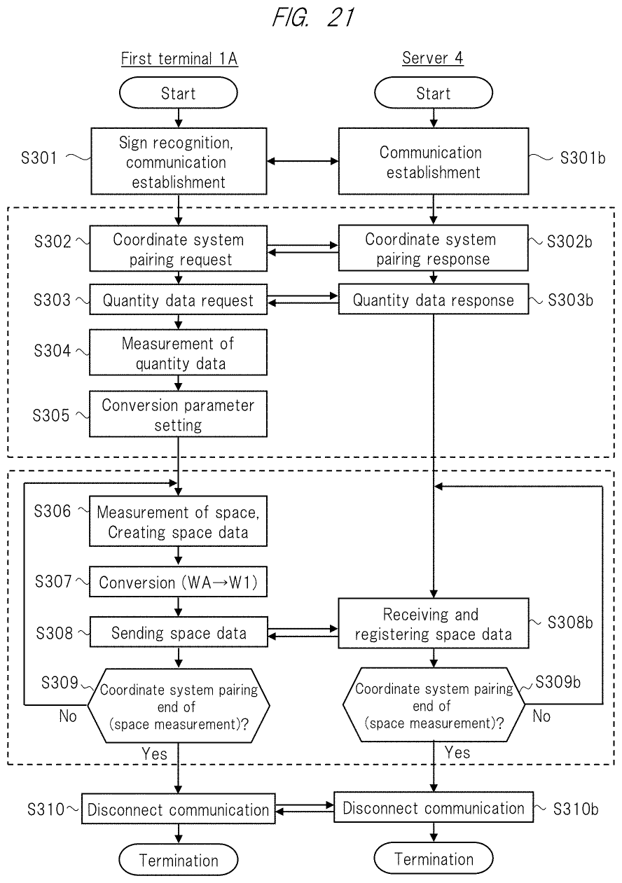

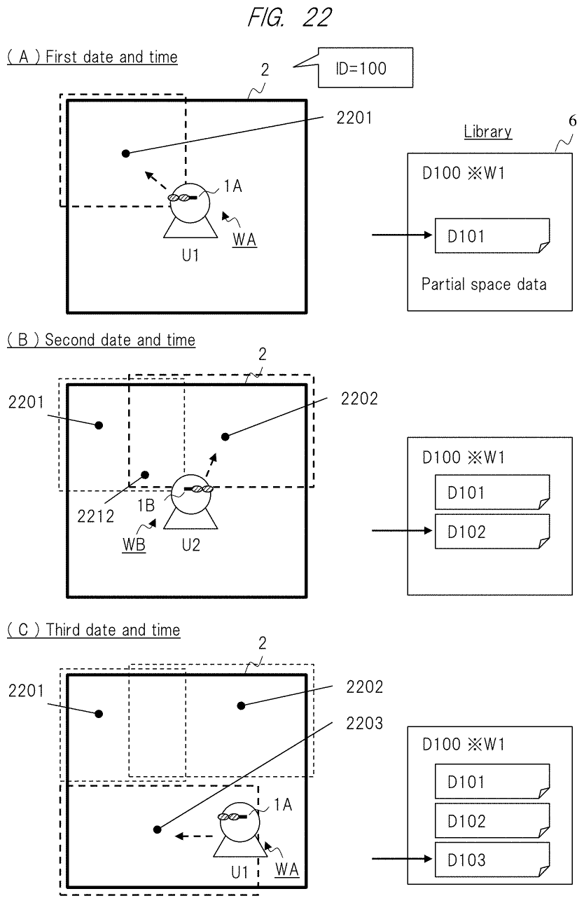

FIG. 22 shows an example of sharing on the time axis in the fifth modification. The space 2 is, for example, a large building and has an ID=100. The space 2 may have a plurality of rooms, areas, and the like (not shown). There are, for example, two users (U1, U2) and two corresponding terminals 1 (1A, 1B) as the users to be shared. An object of the work here is to create the space data 6 (referred to as D100) in the unit of the space 2, which is described in the space coordinate system W1.

(A) of FIG. 22 shows the state at a first date and time. At the first date and time, the user U1 measures an area 2201 in the space 2 by the first terminal 1A, creates a partial space data D101 representing the shape of the area 2201 and the like, and registers it in the library of the DB 5 of the server 4. The area 2201 may be an area determined in advance by sharing, or may be an area arbitrarily measured by the user U1 at that time.

(B) of FIG. 22 shows the state at a second date and time. At the second date and time, the user U2 measures an area 2202 in the space 2 by the second terminal 1B, creates a partial space data D102, and registers it in the library of the DB 5 of the server 4. The area 2202 is an area separated from the area 2201 and may include an overlapped area (e.g., an overlapped area 2212). The partial space data D102 contains data in an area that does not overlap at least a partial space data D101.

(C) of FIG. 22 shows the state at a third date and time. At the third date and time, the user U1 measures an area 2203 in the space 2 by the first terminal 1A, creates a partial space data D103, and registers it in the library of the DB 5 of the server 4. The area 2203 is an area separated from the areas 2201, 2202 and may include an overlapped area.

As described above, in the DB 5 of the server 4, space data 6 (in particular, space shape data 61) about the space 2 (ID=100) is stored. The content of the space data 6 is updated on the time axis at any time. For example, at the third date and time, the space data D100 is composed of a partial space data D101, D102, D103. Each partial space data may have measurement date and time information, measurement user and terminal information, status information such as “measured”, and the like. Thereafter, similarly, by appropriately measuring an arbitrary area in the space 2 by one or more arbitrary users or arbitrary terminals 1 on the time axis, if a sufficient area in the space 2 has been measured, the space data 6 can be created in units of the space 2.

Before the start of each measurement, each terminal 1 can grasp a measured area in the space 2 by referring to the space data 6 from the server 4. Therefore, the terminal 1 can omit the measurement for the measured area and start the measurement for an unmeasured area. In addition, the terminal 1 can update or correct the shape or the like of the area when measuring the measured area again.

The following methods are possible for handling overlapped areas of measurements (e.g., an overlapped area 2212). As the first method, each partial space data is provided with data of the overlapped area. For example, in the partial space data D101 and D102, it has data in the overlapped area 2212.

As a second method, each partial space data does not have data of the overlapped area. For example, in a partial space data D101 or D102, there is no data of the overlapped area 2212. The terminal 1 or the server 4 determines whether or not a certain area in the space 2 has been measured. For example, the determination can be made based on the state of the contents of the registered space data 6. For example, in the second terminal 1B and the server 4, since there is already data of the overlapped area 2212 in the partial space data D101, the data in the overlapped area 2212 is not provided in the partial space data D102. Alternatively, as another method, the second terminal 1B and server 4 overwrite the data of the overlapped area 2212 in the partial space data D101 with the data of the overlapped area 2212 of the partial space data D102.

For the area in the space 2, there is a case where the state such as the shape or the like in that area on the time axis is changed. For example, an arrangement such as a desk or the like may be moved. In this case, the terminal 1 and the server 4 can determine the change by looking at the difference between the measurement data or the partial space data for each area on the time axis. Based on this determination, for example, when it is desired to reflect the latest state of the space 2, the terminal 1 and the server 4 may perform the overwrite update using the partial space data at the newer measurement date and time. In addition, the terminal 1 and the server 4 can also determine a distinction between fixed arrangements (e.g., a wall, a floor, or a ceiling) constituting the space 2 and variable position arrangements (e.g., a desk) based on such a determination. Based on this, the terminal 1 and the server 4 may register the attribute information in the space data 6 by distinguishing between the fixed arrangements and the variable position arrangements for each part. In addition, the space data 6 may be configured so that the variable position arrangements are not components in the first place.

In the DB 5 of the servers 4, only the space data of the latest measurement date and time may be held as the space data 6 of the same space 2, or the space data of each measurement date and time may be held as a history. In this case, the change of the space 2 on the time axis can be grasped as a history. From the difference of the space data of each measurement date and time, it is also possible to discriminate between the fixed arrangements and the variable position arrangements.

### [Sixth Modification]

As a modification (referred to as a sixth modification) of the first to third embodiments, the following is also possible. In the sixth modification, when the space data 6 is generated by measuring a certain space 2, each terminal 1 does not share the measurement in advance. In this case, either one or more users can be used. Each terminal 1 provides the measured space data to another terminal 1 if requested, or registers it in the server 4. Each terminal 1 retrieves, acquires and uses the space data 6 not owned by the own device from the other terminal 1 and the server 4.

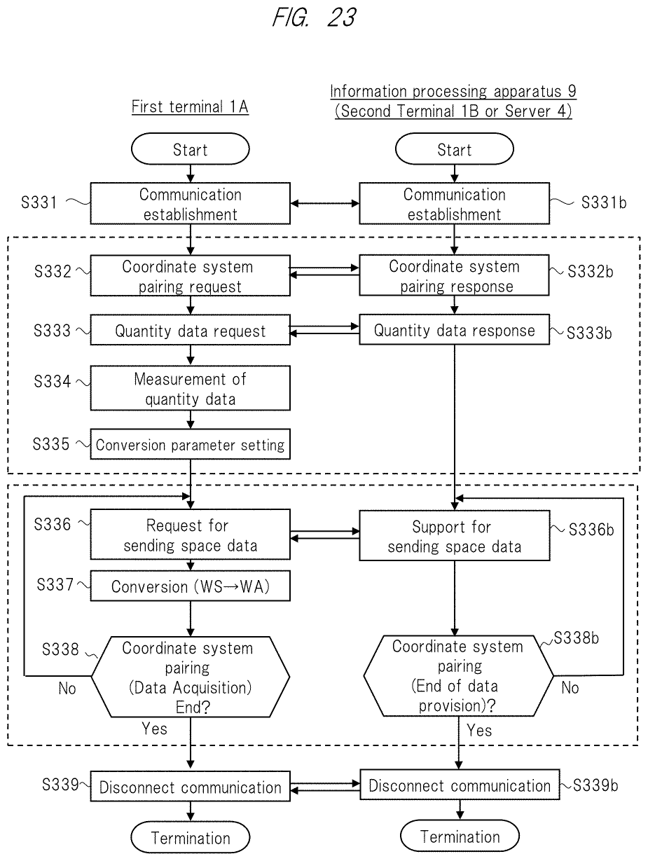

The flow of the sixth modification is shown in FIG. 23. The information processing apparatus 9 is a terminal 1 (for example, a second terminal 1B) or a server 4. Before the flow of FIG. 23, the terminal 1 measures and holds the space data 6, and the server 4 registers the measured space data 6, for example, as shown in the flow of FIG. 21. Further, the server 4 may hold space data 6 as design data of a wall of a building or the like.

In steps S331, S331b, the first terminal 1A and the information processing device 9 establish communication to each other. When the information processing apparatus 9 is a server 4, when establishing communication, the first terminal 1A selects the server 4 that manages the space data 6 to be acquired. The selection can be made, for example, from the position information of the space data 6. Alternatively, a predetermined information (e.g., ID and space data acquisition destination information) may be read by recognizing the mark 3, and a communication connection with the server 4 may be established based on the predetermined information. When the information processing apparatus 9 is the second terminal 1B, since the apparatus can be specified specifically, communication can be established using the communication data held in advance.

In step S332, the first terminal 1A transmits a coordinate system pairing request to the information processing apparatus 9, and in step S332b, the information processing apparatus 9 transmits a coordinate system pairing response to the first terminal 1A.

In step S333, the terminal 1 transmits a request for various quantity data to the information processing apparatus 9. This quantity data is a quantity data relating to the second terminal 1B when the information processing device 9 is the second terminal 1B. When the information processing apparatus 9 is the server 4, the quantity data is the quantity data relating to the mark 3. In step S333b, the information processing apparatus 9 transmits the requested quantity data to the first terminal 1A. The first terminal 1A acquires the quantities. When the common coordinate system for acquiring the space data 6 from the second terminal 1B is the space coordinate system, the first terminal 1A acquires various quantity data such as the mark 3 or the like required for the coordinate system pairing with the space coordinate system from the second terminal 1B and the like.

In step S334, the first terminal 1A measures predetermined features (e.g., the point p1 and the lines v1, v2 in FIG. 20) of the second terminal 1B or the mark 3 required for the coordinate system pairing in the terminal coordinate system WA based on the acquired quantity data, and obtains the measured quantity data as the quantity data of the own device. The measurement at this time is possible by means of the ranging sensor 13.

In step S335, the first terminal 1A calculates the conversion parameter 7 between the terminal coordinate system WA and the common coordinate system WS using the various quantity data described in the common coordinate system WS on the side of the second terminal 1B or the mark 3 obtained in the step S333 and the various quantity data described in the terminal coordinate system WA on the own device side obtained in the step S334, and sets it to the own device. As a result, a sharing of space recognition between the first terminal 1A and the information processing device 9 can be obtained.

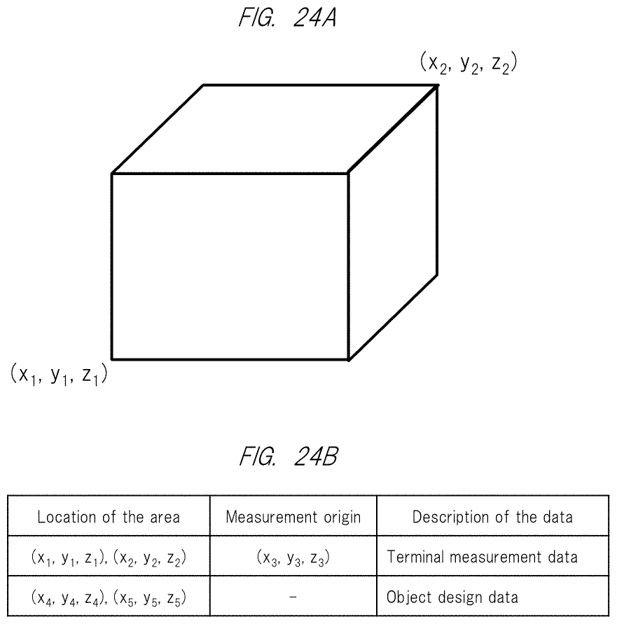

In steps S336, S336b, the first terminal 1A makes an inquiry about holding the space data 6, and the information processing device 9 makes inquiry responses and transmits the space data 6. First, the first terminal 1A transmits the position information described based on the common coordinate system of the area in which the space data 6 is to be acquired to the information processing apparatus 9. The information processing apparatus 9 answers a list of the space data 6 related to the area that has received the inquiry. The area referred to here is a three-dimensional area surrounded by a rectangular parallelepiped defined by coordinate values, for example, as shown in FIG. 24A, and specifies a partial area of the space 2 in detail. In this case, the space mesh may be defined in advance and specified by the ID of the space mesh. The space data 6 relating to an area is three-dimensional positional information such as an object at least partially present in the area, a feature point such as a boundary of a real space, a feature line, polygon data, and the like. The list of the space data 6 is, for example, as shown in FIG. 24B. The position of the area on the list is the range in which the position information such as an object exists, and it does not necessarily coincide with the area of the inquiry. If each side of the area is a rectangular parallelepiped which is parallel to the coordinate axis, the designation of the area may be the coordinate values at both ends of one diagonal of the rectangular parallelepiped. If the area is any polyhedron, all vertex coordinates shall be designated. An answer by the information processing apparatus 9 may include the space data 6 in the vicinity of the inquired area. Upon receiving the reply, the first terminal 1A selects the space data 6 to be acquired from the list and receives a transmission of the space data 6 from the information processing apparatus 9.

In step S337, the first terminal 1A converts the space data 6 acquired in step S336 into the space data 6 described by the terminal coordinate system WA of its own device using the conversion parameter 7 and uses it.

In another method, the conversion parameter 7 may be transmitted to the information terminal device 9, and relating to the positional information, information exchange with reference to the terminal coordinate system WA may be performed.

In steps S338, S338b, the first terminal 1A and the information processing device 9 confirm whether or not the coordinate system pairing related to the provision of the space data is to be terminated, and in the case of termination (Yes), the process proceeds to the steps S339, S339b, and in the case of continuation (No), the process returns to the steps S336, S336b and is repeated in the same manner.

In steps S309, S309b, the first terminal 1A and the information processing apparatus 9 disconnect the communication connection related to the provision of the space data. The first terminal 1A and the information processing device 9 may explicitly cancel the status of the coordinate system pairing (for example, deletion of the conversion parameter 7), or may continue thereafter. The first terminal 1A may be connected to the information processing apparatus 9 at all times via communication, or may be connected to the information processing apparatus 9 only when it is necessary. Basically, a method (client-server method) that does not hold data such as the space data 6 in the terminal 1 may be used. In this case, a server is not the server 4 as the information processing apparatus 9.

In addition to integrating the acquired space data 6 to create the new space data 6, the terminal 1 may only use the space data 6 acquired from the information processing apparatus for displaying the AR object or the like.

According to the sixth modification, it is possible to omit the measurement of the space data 6 by the own device without having to perform the measurement sharing setting in advance, and it is possible also to improve the efficiency of the operation.

### Fourth Embodiment

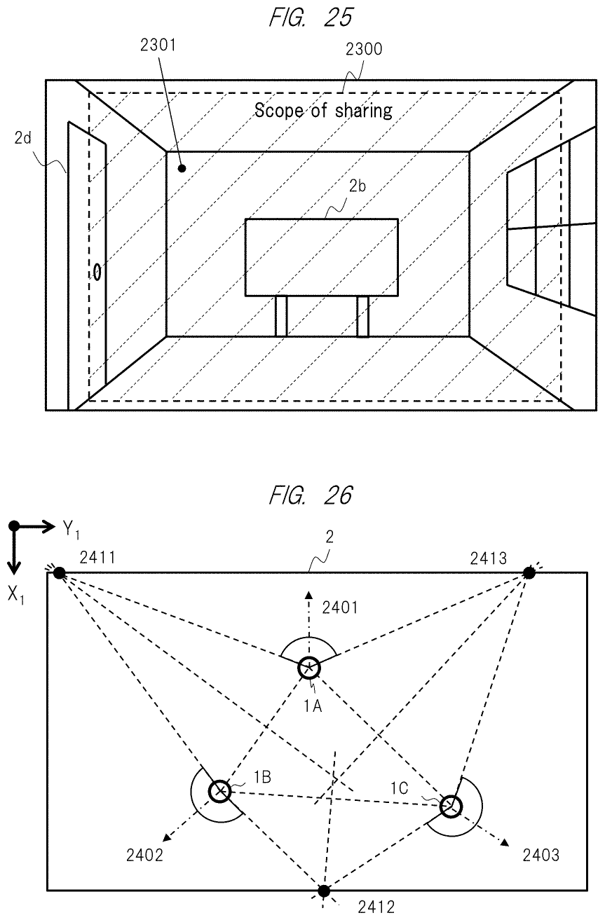

A space recognition system and the like according to the fourth embodiment will be described with reference to FIG. 25 and the like. The fourth embodiment is a modification of the first to third embodiments, and functions are added. The terminal 1 displays, to the user, an image for guidance and support such as a measurement range related to sharing on the display surface 11 in accordance with the position and orientation of the terminal 1. For the position of the terminal 1, the position on the horizontal plane at the time of the coordinate system pairing is used.

### [First Display Example]

FIG. 25 shows a display example of the display surface 11 of the terminal 1 according to the fourth embodiment. In this example, a user U1 wearing an HMD, which is the first terminal 1A, is present in the space 2 shown in FIG. 3. The user U1 is looking the wall 2301 on which the whiteboard 2b is located through the display surface 11 of the HMD. In the first terminal 1A, for example, in step S2A of FIG. 10 described above, it is assumed that an area related to sharing is set in advance. This setting may be the setting for the space data 6 of the DB 5 of the server 4. For example, the first terminal 1A of the user U1 shares in charge of area 2A as shown in FIGS. 3 and 4.

The first terminal 1A superimposes and displays an image 2300 representing an area 2A (i.e., an area to be measured) or a measuring range or the like shared by the own device on the display surface 11. The image 2300 indicates that an area in a direction in which the image 2300 is visible is a shared area. In this example, the image 2300 is an image representing the boundary surface of the areas 2A, 2B in the space 2 (an image in which the back is visible through), but is not limited thereto, it may be an image representing a three-dimensional area 2A or the like. In this example, the position of the first terminal 1A (the corresponding user U1) in the space coordinate system W1 is outside the area 2A and facing the area 2A. Therefore, the boundary surface of the areas 2A, 2B is displayed as the image 2300. In addition, for example, when the position of the first terminal 1A is inside the area 2A and is oriented toward the arrangement in the area 2A, an image representing the state is displayed instead of the image 2300.

The user U1 can easily grasp and measure the area 2A by viewing the images 2300. The user U1 may measure the direction in which the image 2300 is visible. When the sensitivity area of the sensor (e.g., the ranging sensor 13) for measurement provided in the terminal 1 is in the front direction of the face of the user U1, the user U1 may use this image 2300 as a guideline for the direction in which the face is directed for measurement. In other words, the user U1 may turn around the face such that a line of sight points within the surface area of the image 2300 at the time of measurement.

As another example, the first terminal 1A may display another image representing an area (area 2B) shared by the other terminal 1 (e.g., the second terminal 1B) in addition to the image 2300 in accordance with the position and orientation.

FIG. 26 shows an outline of a horizontal plane (X₁-Y₁ plane) with an overview of the space 2 as an example of a sharing method. This sharing shows an example in which the direction of measurement is set when the object space 2 is measured by a plurality of terminals 1 at the same time. In this case, the orientation of the measurement of each terminal 1 is determined in a horizontal plane so as to cover the entire orientation of the space 2 of interest (the corresponding area) by means of a plurality of terminals 1. The plurality of terminals 1 to be shared perform coordinate system pairing with each other. Thereafter, processing for sharing is performed between the terminals 1 while appropriately communicating with each other.

In this example, positions and directions (2401, 2402, 2403) are shown when the terminal 1 (1A, 1B, 1C) of the three users (U1, U2, U3) simultaneously measure the position and the direction. Between the terminals 1, the sharing range is first calculated in this state. Intersection points (2411, 2412, 2413) between a vertical bisector of a line segment connecting adjacent terminals 1 and a boundary line (in this example, a four-sided wall) of the space 2 are taken. This intersection point is defined as a boundary of the sharing range of the space 2 (a corresponding vertical line). In addition, among the terminals 1, the sharing range may be set as an initial value, and further, adjustment may be performed (for example, the intersection may be shifted in the horizontal direction) so that the sharing becomes fair (for example, the same degree of size). Further, in this example, although the sharing range is not overlapped with the intersection point as a boundary, the present invention is not limited to this, and the sharing range may be overlapped with the boundary portion including the intersection point. The shape of the wall or the like of the room can be measured by the measurement in the sharing as shown in FIG. 26.

### [Second Display Example]

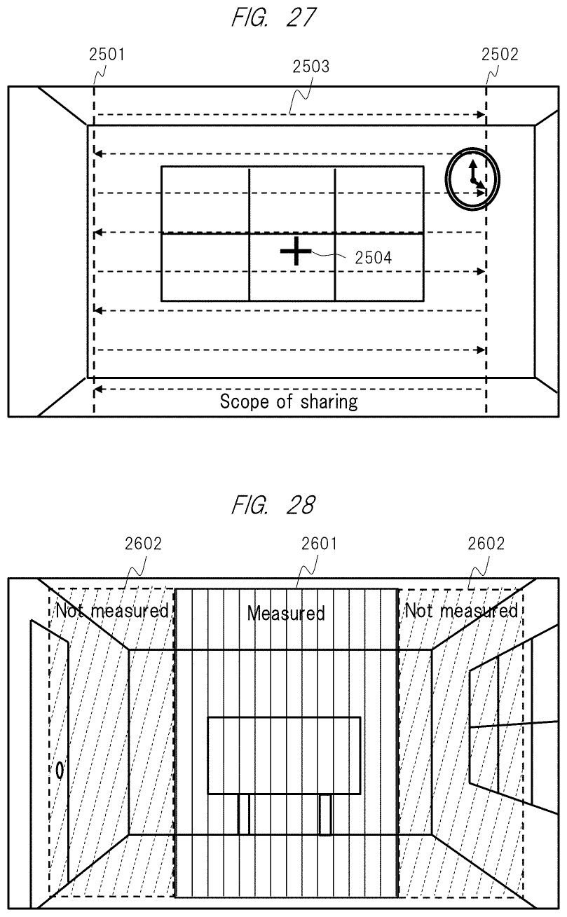

FIG. 27 shows examples of displays on the first terminal 1A corresponding to the sharing shown in FIG. 26. Images 2501 and 2502 representing the measurement range boundary lines corresponding to the intersections 2411 and 2413 are displayed on the display surface 11. Further, in this example, within the measurement range represented by the image 2501 and 2502 of the measurement range boundary, an image 2503 of a plurality of horizontal line arrows is displayed. The horizontal line arrow is a reference of the scanning, when moving the sensor of the terminal 1 (e.g., the ranging sensor 13) to scan during measurement.

By moving the direction of the face of user U1 along the image 2503 of the horizontal line arrow so as to change the orientation of the face (the corresponding image 2504) efficient and accurate measurement can be realized. The image 2504 is an example of a display of an image such as a cursor representing the orientation of an HMD, a sensor, etc. The direction and spacing of the horizontal line arrows in the image 2503 is designed to enable efficient measurement. For example, the interval between two adjacent horizontal line arrows is selected as an interval at which measurement overlap is minimized without occurrence of measurement leakage.

### [Third Display Example]

FIG. 28 shows another display example. The terminal 1 grasps whether or not measurement (in other words, acquisition of measurement data) has been completed for each area in the space 2 or the shared area, and displays an image that distinguishes the measured area from the unmeasured area on the display surface 11 so that the user can easily understand the measured area and the unmeasured area. Further, the terminal 1 may recognize whether or not an area already registered as the space data 6 (in particular, the space shape data 61) in the library of the DB 5 of the server 4, and display an image representing the areas distinguished from each other. In this example, image 2601 is an image, such as a vertical line hatching, representing a measured range. An image 2602 is an image, such as hatching, representing an unmeasured range. The display status of these images is updated in real time. The image may be displayed with a character string or icon representing the type of “measured”, “unmeasured”, “registered”, and “shared range”. Not only image display but also guidance by sound output may be used.

### [Fourth Display Example]

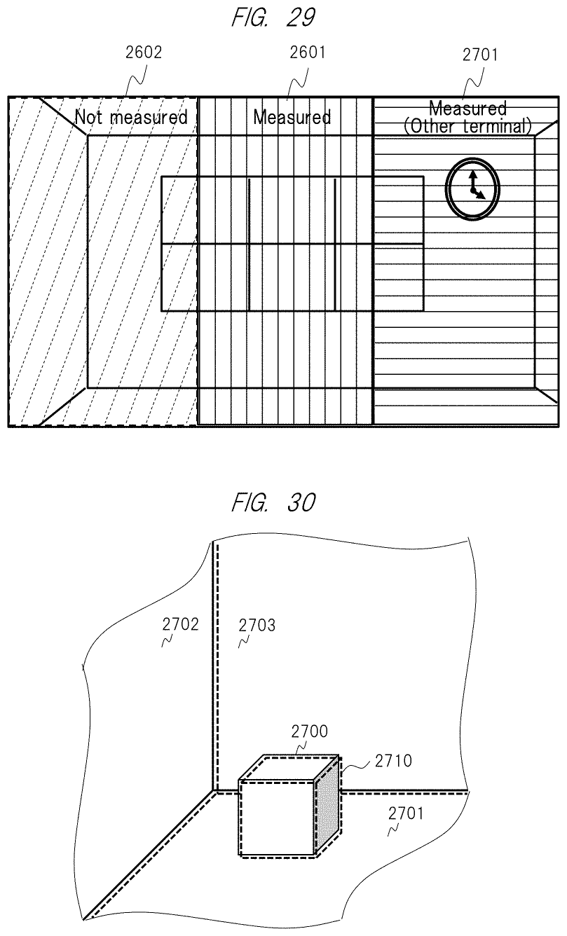

FIG. 29 shows another display example. In this modification, the area of sharing is not determined among the plurality of terminals 1. Each user appropriately measures an arbitrary range by the terminal 1, and voluntarily measures an unmeasured range. When measuring the space 2, each terminal 1 measures a range corresponding to the position and orientation of the user. Each terminal 1, similarly to FIG. 28, displays an image so that the measured range and the unmeasured range by the own device can be seen by the user. For example, the first terminal 1A displays the images 2601 and 2602. Each time measurement is performed, measurement data or information representing the measured area of the terminal 1 itself is transmitted to the other terminals 1. Each terminal 1 grasps a measured area or an unmeasured area by each terminal 1 in the space 2 based on the measurement data or information. When there is an area already measured by another terminal 1 within the range of the display surface 11, each terminal 1 displays an image representing the measured area. For example, the first terminal 1A displays an image 2701 such as a horizontal hatching image representing the measured image by the second terminal 1B. The user U1 can easily determine the next measurement range by viewing the guide image. Not limited to the above example, collectively at all terminals 1 to be shared may be two types of images measured and not measured.

### [Fifth Display Example]

FIG. 30 shows a display example of another image. In the example of FIG. 25 or the like, a guide image representing a surface or the like is displayed in the real space, but the present invention is not limited to this, and a guide image may be displayed so as to match the surface of an object such as a wall or a desk of the space 2. In this example, an object 2700 is disposed on a floor 2701 at a corner near walls 2702 and 2703 in the space 2 such as a room. When the range including the object 2700 is measured, the terminal 1 displays an image 2710 such as a broken line representing the measured range. For example, the terminal 1 can display an image 2710 representing the shape of the object of the measured range, based on the point group data acquired by the ranging sensor 13, in accordance with the surface of the object represented by the point group. The image 2710 may be a line image or a plane image.

Although the present invention has been specifically described based on the embodiments described above, the present invention is not limited to the embodiments described above, and various modifications can be made without departing from the gist thereof. It is possible to add, delete, replace, or combine the components of the Fifths. Some or all of the functions described above may be implemented in hardware, or may be implemented in software program processing. Programs and data comprising functions and the like may be stored in a computer-readable storage medium or may be stored in a device on a communication network.

### DESCRIPTION OF SYMBOLS

1: terminal (HMD), 1A: first terminal, 1B: second terminal, 1a, 1b: smart phone, 2: space, 4: server, 6: space data, 7: conversion parameter, 9: information processor, 11: display surface, 12: camera, 13: ranging sensor, U1: first user, U2: second user, W1: space coordinate system, WA: first terminal system, WB: second terminal coordinate system, WS: common coordinate system, WT: terminal coordinate system, 21: position, 22: image.

1. A space recognition system comprising an information terminal including a function of measuring a space and a function of displaying a virtual image on a display surface and having a terminal coordinate system, and an information processing apparatus which performs processing based on a common coordinate system,
the information terminal measures a relationship relating to a position and an orientation between the terminal coordinate system and the common coordinate system, and matches the terminal coordinate system and the common coordinate system based on data representing the measured relationship,
the information terminal and the information processing apparatus share recognition of the space,

2. The space recognition system according to claim 1,
wherein a plurality of information terminals are provided as the information terminal,
among the plurality of information terminals, having a first terminal coordinate system serving as the common coordinate system, and when the first information terminal serving as the information processing apparatus and the second information terminal having the second terminal coordinate system share the recognition of the space,
the second information terminal measures the relationship relating to the position and the orientation with the first information terminal, matches the first terminal coordinate system with the second terminal coordinate system based on data representing the measured relationship, and shares the recognition of the space.

3. The space recognition system according to claim 1,
wherein a space coordinate system of the space is the common coordinate system,
the information terminal measures a relationship relating to the position and the orientation between an object having a predetermined feature in the space, matches the terminal coordinate system and the space coordinate system based on data representing the measured relationship, and performs sharing of the recognition of the space between the information processing apparatus and the information processing apparatus.

4. The space recognition system according to claim 1,
wherein a plurality of information terminals are provided as the information terminal,
when the plurality of information terminals share and measure the space to obtain space data,
the information terminal or the information processing apparatus integrates partial space data measured by each of the information terminals to create the space data in a space unit.

5. The space recognition system according to claim 2,
wherein when the first information terminal and the second information terminal share and measure the space,
the first information terminal measures a first area of the space by the first terminal coordinate system, and creates first partial space data described in the first terminal coordinate system,
the second information terminal measures a second area of the space by the second terminal coordinate system, and creates second partial space data described in the second terminal coordinate system, and
the first information terminal or the second information terminal converts the second partial space data into partial space data described in the first terminal coordinate system, and integrates the first partial space data and the partial space data described in the first terminal coordinate system to generate a space data in a space unit.

6. The space recognition system according to claim 3,
wherein a plurality of information terminals are provided as the information terminals,
when a first information terminal having a first terminal coordinate system and a second information terminal having a second terminal coordinate system among the plurality of information terminals share and measure the space,
the first information terminal measures a first area of the space by the first terminal coordinate system, creates first partial space data described in the first terminal coordinate system, and converts the first partial space data into first partial space data described in the space coordinate system,
the second information terminal measures a second area of the space by the second terminal coordinate system, creates second partial space data described in the second terminal coordinate system, and converts the second partial space data into second partial space data described in the space coordinate system,
the first information terminal or the second information terminal also serves as the information processing apparatus, and integrates the first partial space data described in the space coordinate system and the second partial space data described in the space coordinate system to create the space data in a space unit.

7. The space recognition system according to claim 5,
wherein the second information terminal generates a conversion parameter for matching the first terminal coordinate system and the second terminal coordinate system, and sets the conversion parameter in the second information terminal itself as an own device.

8. The space recognition system according to claim 6,
wherein the first information terminal generates a conversion parameter for matching the first terminal coordinate system with the space coordinate system, and sets the conversion parameter in the first information terminal itself as an own device, and
the second information terminal generates a conversion parameter for matching the second terminal coordinate system with the space coordinate system, and sets the conversion parameter in the second information terminal itself as an own device.

9.-11. (canceled)

12. The space recognition system according to claim 11,
wherein the server device is registered a data for displaying the virtual image in the space, in association with the space data.

13. The space recognition system according to claim 3,
wherein the information terminal measures, as the relationship, a quantity representing a relative orientation relationship between the terminal coordinate system and the space coordinate system, and a quantity representing a relative positional relationship between an origin of the terminal coordinate system and an origin of the space coordinate system.

14. The space recognition system according to claim 3,
wherein a mark is provided as the object provided in association with the space,
the information terminal measures a relationship relating to the position and orientation between the mark, and matches the terminal coordinate system and the space coordinate system based on a data representing the measured relationship.

15. The space recognition system according to claim 14,
wherein the information terminal recognizes the mark, reads predetermined information described in the mark, and specifies space data associated with the space using the predetermined information.

16. The space recognition system according to claim 2,
wherein when the first information terminal having the first terminal coordinate system, the second information terminal having the second terminal coordinate system, and the third information terminal having the third terminal coordinate system among the plurality of information terminals share and measure the space,
the first information terminal matches the first terminal coordinate system and the second terminal coordinate system with the second information terminal,
the second information terminal matches the second terminal coordinate system and the third terminal coordinate system with the third information terminal,
the third information terminal uses information obtained from the second information terminal to match the third terminal coordinate system and the first terminal coordinate system.

17. The space recognition system according to claim 4,
wherein the plurality of information terminals measure the space in a temporally shared manner,
the information terminals integrate a plurality of partial space data created by the temporally shared measurement to create the space data in space units.

18. The space recognition system according to claim 3,
wherein the space coordinate system of the space is a coordinate system common to a plurality of spaces in the real world.

19.-21. (canceled)

22. A space recognition method in a space recognition system comprising: an information terminal including a function of measuring a space and a function of displaying a virtual image on a display surface and having a terminal coordinate system; and an information processing apparatus which performs processing based on a common coordinate system; the method comprising
a step in which the information terminal measures a relationship relating to a position and an orientation between the terminal coordinate system and the common coordinate system, and matches the terminal coordinate system and the common coordinate system based on data representing the measured relationship; and
a step in which the information terminal and the information processing apparatus share recognition of the space.

23. The space recognition method according to claim 22, further comprising;
a step of obtaining space data by sharing and measuring the space by a plurality of information terminals as the information terminals, and
a step of integrating partial space data obtained by measurement by each of the information terminals to create the space data in space units.

24. An information terminal in a space recognition system; the information terminal including a function of measuring a space and a function of displaying a virtual image on a display surface and having a terminal coordinate system; and an information processing apparatus for performing processing based on a common coordinate system for providing space data of the space,
the information terminal measures a relationship relating to a position and an orientation between the terminal coordinate system and the common coordinate system describing the space data, and matches the terminal coordinate system and the common coordinate system based on data representing the measured relationship, and
the information terminal uses the space data described in the common coordinate system.

25. The information terminal according to claim 24,
wherein when a plurality of information terminals as the information terminals share and measure the space to obtain space data,
the information terminal integrates the partial space data obtained by the measurement to generate the space data in space units.

26.-27. (canceled)
